(19) United States
(12) Patent Application Publication
(10) Pub. No.: US 2025/0131590 A1
(43) Pub. Date: Apr. 24, 2025

(54) Screen Position Estimation

(71) Applicant: zSpace, Inc., San Jose, CA (US)

(72) Inventor: Oleg Ovechkin, Mercer Island, WA (US)

(21) Appl. No.: 18/492,963

(22) Filed: Oct. 24, 2023

(51) Int. Cl. G06T 7/73

(52) U.S. Cl. CPC G06T 7/74; G06T 2207/30204

(57) ABSTRACT

Systems and methods for display position estimation, e.g., in a three-dimensional (3D) display system rendering interactive augmented reality (AR) and/or virtual reality (VR) experiences. A portable computer system may receive one or more images of a portion of the portable computer system captured via at least one camera, e.g., via at least one camera of a portable device. The one or more images may be received via wireless communications with the portable device and/or via an input/output bus and/or peripheral bus between the portable device and the portable computer system. The portable computer system may compare the one or more images to a set of cached images of the portable computer system and determine, e.g., based on the comparison, the angle of the display relative to the base of the portable computer system.

### TECHNICAL FIELD

This disclosure relates to the field of digital display and more particularly to systems, mechanisms, and methods for display position estimation, e.g., in a three-dimensional (3D) display system rendering interactive augmented reality (AR) and/or virtual reality (VR) experiences.

### DESCRIPTION OF THE RELATED ART

Three-dimensional (3D) displays (actually, simulated 3D, e.g., via stereoscopic display (SD) techniques) are increasingly utilized for a variety of applications, including, for example, remote viewing, videoconferencing, video collaboration, and so forth.

A typical 3D display chain includes a graphics processing unit (GPU), a scaler, and a panel. The GPU resides on a personal computer, workstation, or functional equivalent, e.g., such as various user equipment devices (UEs) and outputs video levels for each color or channel of a supported color model, e.g., for each of three colors, typically Red display, Green (G), and Blue (B), for each pixel on the display. Each of these numbers is typically an 8-bit number, with a range of 0 to 255, although other ranges are possible. The scaler takes as input the video levels (e.g., for R, G, and B) for each pixel output from the GPU, and processes them in various ways, before outputting (usually) modified video levels for RGB, usually in the same 8-bit range of 0-255. This component may also scale an image from the input resolution to a different, rendered resolution supported by the display. The panel is the display itself, typically a liquid crystal display (LCD), although other displays are possible, and takes as input the video levels (e.g., for R, G and B) output from the scaler for each pixel, and converts the video levels to voltages, which are then delivered to each pixel on the display. The panel itself may modify the video levels before converting them to voltages.

The 3D display chain generally modifies the video levels in two ways, specifically gamma correction and overdrive. Note that the functionality described above is typically implemented in the scaler, but is sometimes implemented at least partially in other devices or elements of the 3D display chain, e.g., in the GPU or display device (panel).

### SUMMARY

Embodiments relate to the field of digital display and more particularly to systems, mechanisms, and methods for display position estimation, e.g., in a three-dimensional (3D) display system rendering interactive augmented reality (AR) and/or virtual reality (VR) experiences. Embodiments described herein may include methods performed by a portable device, e.g., a Universal Serial Bus (USB) device comprising at least one camera, a portable device comprising at least one camera that may be mountable to a display and/or chassis of a computer system (and may include at least one radio configured to communicate with a computer system), and/or a user equipment device (UE), such as a laptop computer, comprising at least one camera arranged to include at least a portion of a display of the laptop within a field of view of the at least one camera and/or a laptop computer comprising at least one camera arranged to include at least a portion of a chassis/keyboard within a field of view of the at least one camera, to track, determine, and/or estimate a position (e.g., angle of orientation) of a display of the laptop computer.

For example, in some embodiments, a portable computer system may receive one or more images of a portion of the portable computer system captured via at least one camera, e.g., via at least one camera of a portable device. The one or more images may be received via wireless communications with the portable device and/or via an input/output bus and/or peripheral bus between the portable device and the portable computer system. The portable computer system may compare the one or more images to a set of cached images of the portable computer system and determine, e.g., based on the comparison, the angle of the display relative to the base of the portable computer system.

As another example, in some embodiments, a device may capture one or more images of a portion of a portable computer system via at least one camera. The device may compare the one or more images to a set of cached images of the portable computer system. The device may determine, e.g., based on the comparison, an angle of a display of the portable computer system relative to the base of the portable computer system. Further, the device may provide the angle of the display to the computer system, e.g., via wireless communications and/or via an input/output bus and/or peripheral bus of the portable computer system.

As a further example, in some embodiments, a portable computer system may capture one or more images of a portion of the portable computer system via at least one camera. Additionally, the portable computer system may compare the one or more images to a set of cached images of the portable computer system and determine, e.g., based on the comparison, the angle of the display relative to the base of the portable computer system.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present disclosure can be obtained when the following detailed description of the preferred embodiment is considered in conjunction with the following drawings, in which:

FIGS. 1A, 1B, 1C and 1D illustrate examples of 3D display systems configured according to some embodiments.

FIG. 2 illustrates an example block diagram of a user equipment device configured according to some embodiments.

FIGS. 3A and 3B illustrate examples of a user input device, according to some embodiments.

FIGS. 4 and 5 illustrate examples of devices, according to some embodiments.

FIGS. 6, 7, and 8 illustrate block diagrams of examples of methods for determining an angle of a display relative to a base of a portable computer system, according to some embodiments.

While the disclosure is susceptible to various modifications and alternative forms, specific embodiments thereof are shown by way of example in the drawings and are herein described in detail. It should be understood, however, that the drawings and detailed description thereto are not intended to limit the disclosure to the particular form disclosed, but on the contrary, the intention is to cover all modifications, equivalents and alternatives falling within the spirit and scope of the present disclosure as defined by the appended claims.

### DETAILED DESCRIPTION

### Terms

The following is a glossary of terms used in the present application:

Memory Medium—any of various types of memory devices or storage devices. The term “memory medium” is intended to include an installation medium, e.g., a CD-ROM, floppy disks, or tape device; a computer system memory or random-access memory such as DRAM, DDR RAM, SRAM, EDO RAM, Rambus RAM, EEPROM, etc.; a non-volatile memory such as a Flash, magnetic media, e.g., a hard drive, or optical storage; registers, or other similar types of memory elements, etc. The memory medium may comprise other types of memory as well or combinations thereof. In addition, the memory medium may be located in a first computer in which the programs are executed, or may be located in a second different computer which connects to the first computer over a network, such as the Internet. In the latter instance, the second computer may provide program instructions to the first computer for execution. The term “memory medium” may include two or more memory mediums which may reside in different locations, e.g., in different computers that are connected over a network.

Carrier Medium—a memory medium as described above, as well as a physical transmission medium, such as a bus, network, and/or other physical transmission medium that conveys signals such as electrical, electromagnetic, or digital signals.

Computer System—any of various types of computing or processing systems, including a personal computer system (PC), mainframe computer system, workstation, network appliance, Internet appliance, personal digital assistant (PDA), smart phone, television system, grid computing system, tablet, or other device or combinations of devices. In general, the term “computer system” can be broadly defined to encompass any device (or combination of devices) having at least one processor that executes instructions from a memory medium.

Graphical Processing Unit—refers to a component that may reside on a personal computer, workstation, server, graphics server, or equivalent, and outputs video levels for each color or channel of a supported color model, e.g., for each of three colors, typically Red (R), Green (G), and Blue (B), for each pixel on the display. Each of these numbers is typically an 8-bit number, with a range of 0 to 255, although other ranges are possible.

Mobile Device (or Mobile Station)—any of various types of computer systems devices which are mobile or portable and which performs wireless communications using WLAN communication. Examples of mobile devices include mobile telephones or smart phones (e.g., iPhone™, Android™-based phones), and tablet computers such as iPad™ Samsung Galaxy™, etc. Various other types of devices would fall into this category if they include Wi-Fi or both cellular and Wi-Fi communication capabilities, such as laptop computers (e.g., MacBook™), portable gaming devices (e.g., Nintendo DS™, PlayStation Portable™, Gameboy Advance™, iPhone™), portable Internet devices, and other handheld devices, as well as wearable devices such as smart watches, smart glasses, headphones, pendants, earpieces, etc. In general, the term “mobile device” can be broadly defined to encompass any electronic, computing, and/or telecommunications device (or combination of devices) which is easily transported by a user and capable of wireless communication using WLAN or Wi-Fi.

Wireless Device (or Wireless Station)—any of various types of computer systems devices which performs wireless communications using WLAN communications. As used herein, the term “wireless device” may refer to a mobile device, as defined above, or to a stationary device, such as a stationary wireless client or a wireless base station. For example, a wireless device may be any type of wireless station of an 802.11 system, such as an access point (AP) or a client station (STA or UE). Further examples include televisions, media players (e.g., AppleTV™, Roku™, Amazon FireTV™, Google Chromecast™, etc.), refrigerators, laundry machines, thermostats, and so forth.

User Equipment (UE) (or “UE Device”)—any of various types of computer systems devices which are mobile or portable and which performs wireless communications. Examples of UE devices include mobile telephones or smart phones (e.g., iPhone™, Android™-based phones), portable gaming devices (e.g., Nintendo DS™ PlayStation Portable™, Gameboy Advance™, iPhone™), laptops, wearable devices (e.g., smart watch, smart glasses), PDAs, portable Internet devices, music players, data storage devices, other handheld devices, unmanned aerial vehicles (UAVs) (e.g., drones), UAV controllers (UACs), and so forth. In general, the term “UE” or “UE device” can be broadly defined to encompass any electronic, computing, and/or telecommunications device (or combination of devices) which is easily transported by a user and capable of wireless communication.

Base Station—The term “Base Station” has the full breadth of its ordinary meaning, and at least includes a wireless communication station installed at a fixed location and used to communicate as part of a wireless telephone system or radio system.

Wi-Fi—The term “Wi-Fi” (or WiFi) has the full breadth of its ordinary meaning, and at least includes a wireless communication network or RAT that is serviced by wireless LAN (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.

WLAN—The term “WLAN” has the full breadth of its ordinary meaning, and at least includes a wireless communication network or RAT that is serviced by WLAN access points and which provides connectivity through these access points to the Internet. Most modern WLANs are based on IEEE 802.11 standards and are marketed under the name “Wi-Fi”. A WLAN network is different from a cellular network.

Processing Element (or Functional Unit)—refers to various implementations of digital circuitry that perform a function in a computer system. Additionally, processing element may refer to various implementations of analog or mixed-signal (combination of analog and digital) circuitry that perform a function (or functions) in a computer or computer system. Processing elements include, for example, circuits such as an integrated circuit (IC), ASIC (Application Specific Integrated Circuit), portions or circuits of individual processor cores, entire processor cores, individual processors, programmable hardware devices such as a field programmable gate array (FPGA), and/or larger portions of systems that include multiple processors.

Coupled Zone—refers to a physical volume in which the user of a 3D stereoscopic display can view 3D content within the human eye's natural depth of field. For example, when a person sees an object in the physical world, the person's eyes converge on, or look (individually aim) at, the object. Additionally, as the two eyes converge on the object, each eye's lens also focuses, via accommodation, (monoscopically) on the object. In this sense, both eyes focus and converge on the object, thus focus and convergence are “coupled.”

Disparity—refers to the difference between the left eye and right eye images of a 3D stereoscopic display. Disparity may be described in at least two ways. First, with respect to the display device, i.e., the 3D stereoscopic display, disparity may be described by the number of pixels of separation between corresponding positions of the image, or content, being displayed, or rendered. In other words, the pixels of separation between the left eye and right eye images, or content. Alternatively, or in addition to, with respect to the point of view of the user, disparity may be described by the degree of angular separation between corresponding positions in the images, or content, being displayed, or rendered, i.e., the angular separation between the left eye and right eye images, or content.

Projection—refers to the display of a 3D object, or content, on a two-dimensional (2D) display. Thus, a projection may be described as the mathematical function applied to objects within a virtual 3D scene to determine the virtual position of the objects within a 3D space that may be defined by the size of the 3D stereoscopic display and the point of view of a user.

Viewpoint—This term has the full extent of its ordinary meaning in the field of computer graphics/cameras and specifies a location and/or orientation. For example, the term “viewpoint” may refer to a single point of view (e.g., for a single eye) or a pair of points of view (e.g., for a pair of eyes). Thus, viewpoint may refer to the view from a single eye, or may refer to the two points of view from a pair of eyes. A “single viewpoint” may specify that the viewpoint refers to only a single point of view and a “paired viewpoint” or “stereoscopic viewpoint” may specify that the viewpoint refers to two points of view (and not one). Where the viewpoint is that of a user, this viewpoint may be referred to as an eyepoint (see below) or “physical viewpoint”. The term “virtual viewpoint” refers to a viewpoint from within a virtual representation or 3D scene. A viewpoint is synonymous with “point of view” (POV). (See definition of POV below.)

Eyepoint—the physical location (and/or orientation) of a single eye or a pair of eyes. A viewpoint above may correspond to the eyepoint of a person. For example, a person's eyepoint has a corresponding viewpoint.

Point of View (POV)—refers to or specifies a position and orientation. For example, a POV may be a viewpoint or eyepoint, generally of a user, but may also be a viewpoint of an optical device, such as a camera. The POV is generally a means to capture a relationship between two or more 6 degree of freedom objects. In a typical application of the present techniques, a user's pair of eyes or head (view) is positioned in any X, Y, Z position and/or pitch, yaw, roll orientation to a display device, e.g., a monitor screen, which may have its own position in any X, Y, Z position and/or pitch, yaw, roll orientation. In this example, the POV can be defined as the position/orientation of the user's view with respect to the positioning/orientation of the display device. The POV determination may be identified by a capture system. In a typical application of the present techniques, one or more tracking devices are attached to the display device, such that the controller knows what the tracking system tracks in the context of the display device, meaning the tracking system, being attached to the display device, is programmatically aware of the position/orientation of the display device, as well as any potential change to the position/orientation of the display device.

The tracking system (which may identify and track, among other things, the user's view) may identify the position/orientation of the user's view, and this information may then be correlated to the tracking system's identification of the viewing device's position/orientation (again, with respect to the display device).

Vertical Perspective—a perspective effect rendered from a viewpoint which is substantially perpendicular to the display surface. “Substantially perpendicular” refers to 90 degrees or variations thereof, such as 89 or 91 degrees, 85-95 degrees, or any variation which does not cause noticeable distortion of the rendered scene. A vertical perspective may be a central perspective, e.g., having a single (and central) vanishing point. As used herein, a vertical perspective may apply to a single image or a stereoscopic image. When used with respect to a stereoscopic image (e.g., presenting a stereoscopic image according to a vertical perspective), each image of the stereoscopic image may be presented according to the vertical perspective, but with differing single viewpoints.

Horizontal or Oblique Perspective—a perspective effect rendered from a viewpoint which is not perpendicular to the display surface. More particularly, the term “horizontal perspective” may typically refer to a perspective effect which is rendered using a substantially 45-degree angled render plane in reference to the corresponding viewpoint. The rendering may be intended for a display which may be positioned horizontally (e.g., parallel to a table surface or floor) in reference to a standing viewpoint. “Substantially 45 degrees” may refer to 45 degrees or variations thereof, such as 44 and 46 degrees, 40-50 degrees, or any variation which may cause minimal distortion of the rendered scene. As used herein, a horizontal perspective may apply to a single image or a stereoscopic image. When used with respect to a stereoscopic image (e.g., presenting a stereoscopic image according to a horizontal perspective), each image of the stereoscopic image may be presented according to the horizontal perspective, but with differing single viewpoints.

Another conception of the horizontal perspective as commonly used in embodiments of the present techniques relates to the projection of the intended rendered graphics to the viewing device. With the POV determined, a horizontal perspective engine may identify the correct graphics frustum in the 3D space, taking into account the position and orientation of the viewing device as defining the render plane of the frustum and the user's view in position and orientation to define a camera point of the frustum in relation to the render plane. The resultant projection is then rendered onto the viewing device as will be seen by the user.

Position—the location or coordinates of an object (either virtual or real). For example, position may include x, y, and z (i.e., location) coordinates within a defined space. The position may be relative or absolute, as desired. Position may also include yaw, pitch, and roll information, e.g., when defining the orientation of a viewpoint. In other words, position is defined broadly so as to encompass information regarding both location and orientation.

Passive Stylus—a peripheral device or element such as a handheld device, handheld pen device, handheld pointing device, hand, finger, glove, or any object used to directly interact with rendered virtual objects as in a stereo rendered virtual projected objects.

Active Stylus—a peripheral device or element that provides additional capabilities to improve accuracy and precision in the determination of a position of the active stylus. These capabilities may include one or more of accelerometers, magnetometers, gyroscopes, global positioning system, compass, and/or gravity sensor. Examples include a handheld device, handheld pen device, handheld pointing device, and/or any object that includes such capabilities and is used to directly interact with rendered virtual objects as in a stereo rendered virtual projected objects.

Similar—as used herein in reference to geometrical shapes, refers to the geometrical term indicating that objects have the same shape, or that one object has the same shape as the mirror image of the other object. In other words, objects are considered similar if one object may be obtained from the other by uniformly scaling (enlarging or shrinking) the object. Additionally, the term similar, or similar objects, means that either object may be rescaled, repositioned, and reflected, so as to coincide with the other object. Thus, for example, if a first object is geometrically similar to a second object, i.e., has the same shape but possibly a different size, then either object may be uniformly scaled to obtain the geometrical size and shape of the other object. Thus, the first object may be uniformly scaled to obtain the second object or the second object may be uniformly scaled to obtain the first object. Note that this definition of similar only refers to the use of the word in the context of geometrical shapes and retains it ordinary meaning in other contexts (e.g., system A is similar to system B implies that system A resembles system B without being identical to system B).

Approximately—refers to a value that is correct or exact within some specified tolerance. For example, approximately may refer to a value that is within 1 to 10 percent of the exact (or desired) value. It should be noted, however, that the actual threshold value (or tolerance) may be application dependent. For example, in one embodiment, “approximately” may mean within 0.1% of some specified or desired value, while in various other embodiments, the threshold may be, for example, 2%, 3%, 5%, and so forth, as desired or as required by the particular application.

Proximate—near to; for example, proximate may mean within some specified distance, or within some specified fraction of a distance. Note that the actual threshold for being proximate is generally application dependent. Thus, in various applications, proximate may mean being within 1 mm, 1 inch, 1 foot, 1 meter, 1 mile, etc. of some reference point or object, or may refer to being within 1%, 2%, 5%, 10%, etc., of a reference distance from some reference point or object.

Substantially—refers to a term of approximation. Similar to the term “approximately,” substantially is meant to refer to some tolerable range. Thus, if part A is substantially horizontal, then part A may be horizontal (90 degrees from vertical), or may be within some tolerable limit of horizontal. For example, in one application, a range of 89-91 degrees from vertical may be tolerable, whereas, in another application, a range of 85-95 degrees from vertical may be tolerable. Further, it may be that the tolerable limit is one-sided. Thus, using the example of “part A is substantially horizontal,” it may be tolerable for Part A to be in a range of 60-90 degrees from vertical, but not greater than 90 degrees from vertical. Alternatively, it may be tolerable for Part A to be in a range of 90-120 degrees from vertical but not less than 90 degrees from vertical. Thus, the tolerable limit, and therefore, the approximation referenced by use of the term substantially may be as desired or as required by the particular application.

Equivalent—refers to an object that is equal to or corresponds with another object in value, measure, function, meaning, effect, significance, appearance, and so forth. For example, a first image may be equivalent to a second image if imagery within the first image corresponds to imagery within the second image. Additionally, a first image may be substantially equivalent to a second image if imagery within the first image at least partially corresponds to imagery with the second image, e.g., within some tolerable range and/or limit.

Concurrent—refers to parallel execution or performance, where tasks, processes, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner, e.g., by time multiplexing of execution threads.

Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually,” where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Comprising—this term is open-ended, and means “including.””. As used in the appended claims, this term does not foreclose additional elements, structure, or steps. Consider a claim that recites: “A system comprising a display . . . ”; such a claim does not foreclose the system from including additional components (e.g., a voltage source, a light source, etc.).

Configured To—various units, circuits, or other components may be described or claimed as “configured to” perform a task or tasks. In such contexts, “configured to” is used to connote structure by indicating that the units/circuits/components include structure (e.g., circuitry) that performs those task or tasks during operation. As such, the unit/circuit/component can be said to be configured to perform the task even when the specified unit/circuit/component is not currently operational (e.g., is not on). The units/circuits/components used with the “configured to” language include hardware for example, circuits, memory storing program instructions executable to implement the operation, etc. Reciting that a unit/circuit/component is “configured to” perform one or more tasks is expressly intended not to invoke 35 U.S.C. § 112(f) for that unit/circuit/component. Additionally, “configured to” can include generic structure (e.g., generic circuitry) that is manipulated by software and/or firmware (e.g., an FPGA or a general-purpose processor executing software) to operate in manner that is capable of performing the task(s) at issue.

First, Second, etc. —these terms are used as labels for nouns that they precede, and do not imply any type of ordering (e.g., spatial, temporal, logical, etc.). For example, in a system having multiple tracking sensors (e.g., cameras), the terms “first” and “second” sensors may be used to refer to any two sensors. In other words, the “first” and “second” sensors are not limited to logical sensors 0 and 1.

Based On—this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

This specification may include references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

### Exemplary Systems

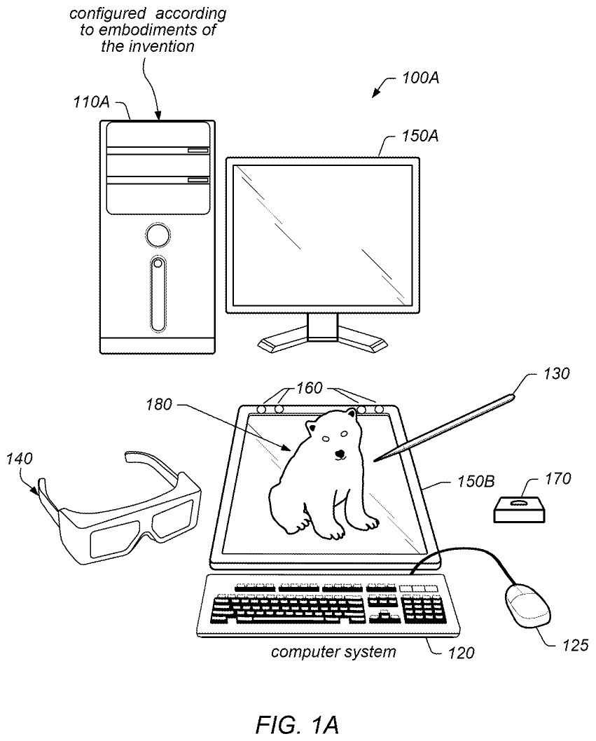

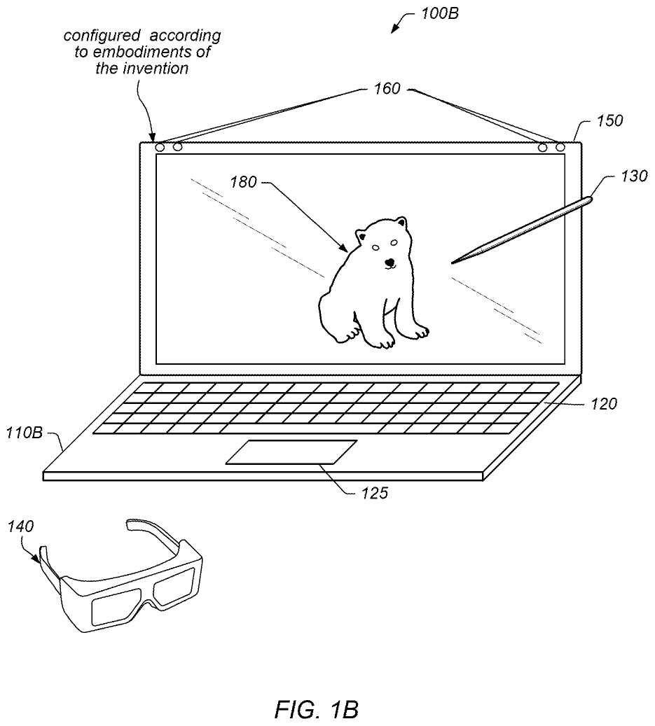

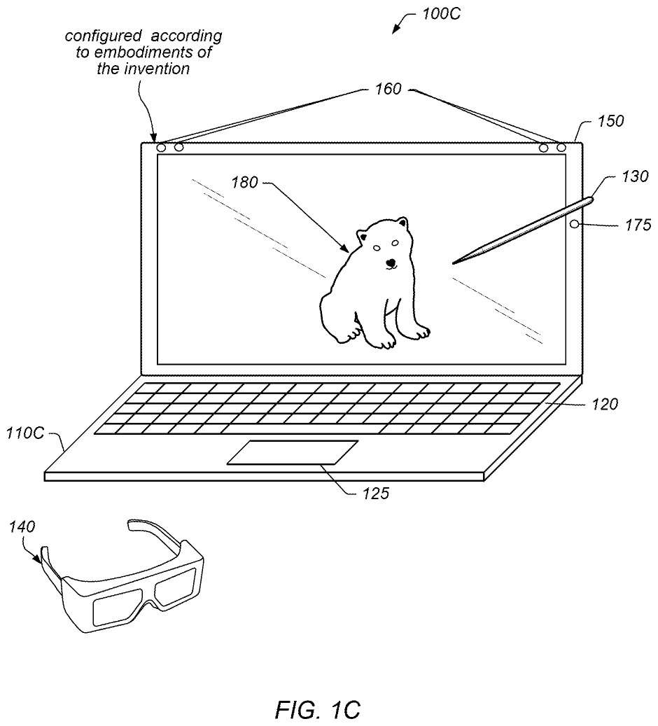

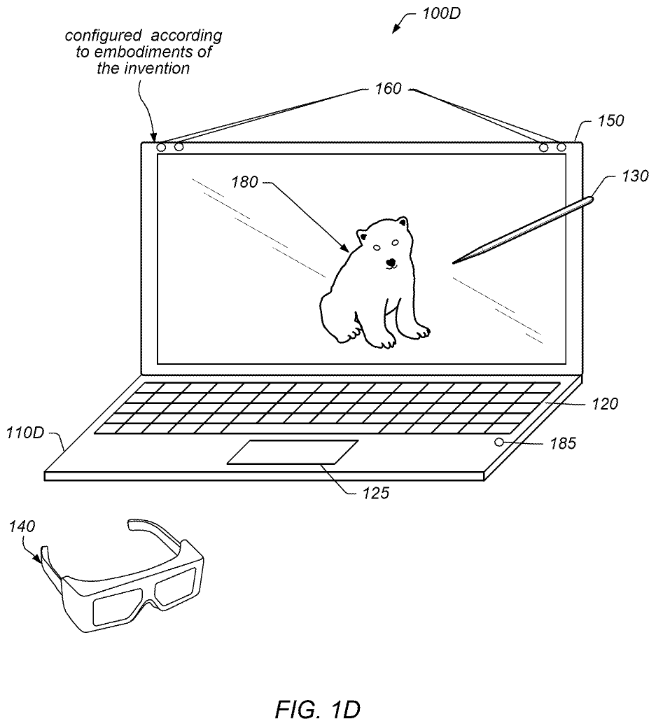

FIGS. 1A, 1B, 1C, and 1D illustrate exemplary systems configured to implement various embodiments of the techniques described below.

In the exemplary example of FIG. 1A, computer system 100A may include chassis 110A, display 150A and display 150B (which may collectively be referred to as display 150 or “one or more displays” 150), keyboard 120, mouse 125, user input device 130, and at least two cameras 160. Additionally, the computer system 100A may optionally include eyewear 140 and/or caddy 170. Note that in some examples, two displays 150A and 150B may not be used; instead, for example, a single display 150 may be used. In various examples, at least one of the displays 150A and 150B may be a stereoscopic display. For example, both of the displays 150A and 150B may be stereoscopic displays. As another example, the single display 150 may be a stereoscopic display. It is noted that a stereoscopic display may also be configured to display two-dimensional (2D) objects and may be configured to operate in a 2D mode.

The chassis 110A may include various computer components such as processors, at least one memory medium (e.g., RAM, ROM, hard drives, etc.), graphics circuitry, audio circuitry, and other circuitry for performing computer tasks, such as those described herein. The at least one memory medium may store one or more computer programs or software components according to various embodiments of the present invention. For example, the memory medium may store one or more graphics engines which are executable to perform some of the techniques described herein. In certain embodiments, the graphics engine may be implemented on or by a functional unit or processing element. As used herein, and as noted in the Terms section above, the term functional unit or processing element refers to any of various elements or combinations of elements configured to process instructions and/or data. Processing elements include, for example, circuits such as an ASIC (Application Specific Integrated Circuit), portions or circuits of individual processor cores, entire processor cores, individual processors, programmable hardware devices such as a field programmable gate array (FPGA), and/or larger portions of systems that include multiple processors, as well as any combinations thereof.

The memory medium (which may include two or more memory mediums) may also store data (and/or program instructions) (e.g., implementing or specifying a computer model) representing a virtual space, which may be used for projecting a 3D scene, such as scene 180, of the virtual space via the display(s) 150. Further, the memory medium may store software which is executable to perform three-dimensional spatial tracking (e.g., user view tracking, user control tracking, etc.), content processing, or other features, as described herein. For example, the computer system may include a tracking system that may track one or more of a user's head, a user's hand, or the stylus. Additionally, the memory medium may store operating system software, as well as other software for operation of the computer system. Various embodiments further include receiving or storing instructions and/or data implemented in accordance with the foregoing description upon a carrier medium.

As indicated above, the computer system 100A may be configured to display a three-dimensional (3D) scene (e.g., via stereoscopic images), or 3D content, such as scene 180, using the display 150A and/or the display 150B. The computer system 100A may also be configured to display a “view” of the 3D scene using the display 150A, the display 150B, and/or another display, as described in more detail below. The “view” of the 3D scene, or content, may refer to a displayed portion of the 3D scene from a viewpoint within the 3D scene. A viewpoint within the 3D scene may be referred to as a “virtual viewpoint.” The view may be stereoscopic, e.g., may be displayed on a stereoscopic display. Alternatively, the view may be monoscopic (not stereoscopic), and may be displayed on either a monoscopic display or a stereoscopic display. Note that a monoscopic image or scene displayed on a stereoscopic display may appear the same as on a monoscopic display system.

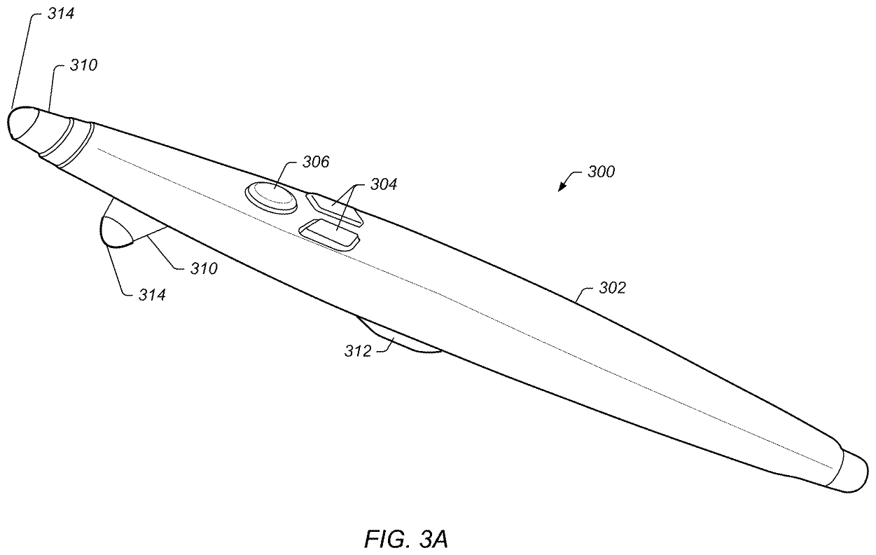

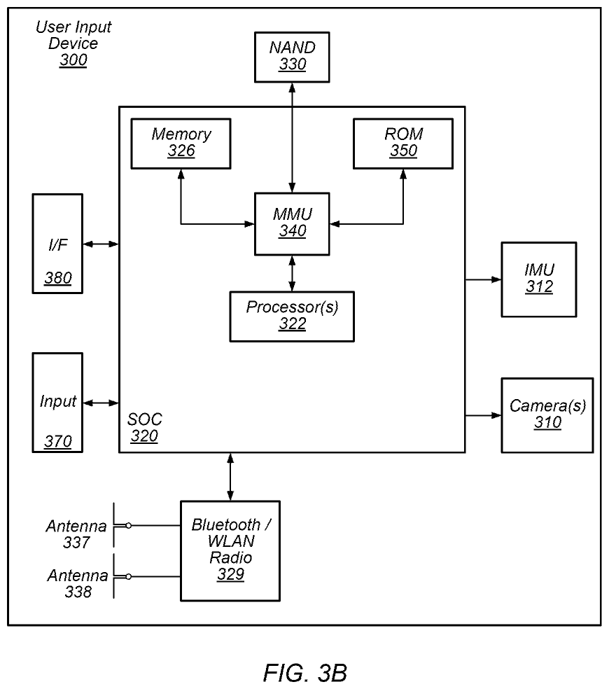

It should be noted that the example of FIG. 1A is exemplary only, and other numbers of displays are also envisioned. For example, the computer system 100A may include only a single display or more than two displays, or the displays may be arranged in different manners than shown, e.g., as goggles or other wearable eyewear or headgear as further described below in reference to FIGS. 3A and 3B. In this particular instance, the display 150A is configured as a vertical display (which may be perpendicular or approximately perpendicular to a user's line of sight) and the display 150B is configured as a horizontal display (which may be parallel (or approximately parallel) or oblique to a user's line of sight). The vertical display 150A may be used (e.g., via instructions sent by a graphics engine executing in the chassis 110A) to provide images which are presented according to a vertical (or central) perspective and the display 150B may be used (e.g., via instructions sent by a graphics engine executing in the chassis 110A) to provide images that are presented according to a horizontal perspective. Descriptions of horizontal and vertical perspectives are provided herein (see, e.g., the above Terms section). Additionally, while the displays 150 are shown as flat panel displays, in other instances, they may be any type of device or system which is capable of displaying images, e.g., projection systems. For example, display(s) 150 may be or include a CRT (cathode ray tube) monitor, an LCD (liquid crystal display) monitor, or a front projection or a back projection screen or surface with a plurality of projectors, among others. Display(s) 150 may include a light emitting diode (LED) backlight or other type of backlight.

Either or both of the displays 150A and 150B may present (display) stereoscopic images for viewing by the user. By presenting stereoscopic images, the display(s) 150 may present a 3D scene for the user. This 3D scene may be considered or referred to as an illusion or simulated 3D because the actual provided images are 2D, but the scene is conveyed in 3D via the user's interpretation of the provided images via stereoscopic effects. In order to properly view the stereoscopic images (one for each eye for each image frame), the user may wear eyewear 140, at least in some instances. Eyewear 140 may be any of anaglyph glasses, polarized glasses, shutter glasses, lenticular glasses, etc., among others. In some instances, the display(s) 150 may be included (or incorporated) in the eyewear (or other wearable headgear). In instances using anaglyph glasses, images for a first eye are presented according to a first color (and the corresponding lens has a corresponding color filter) and images for a second eye are projected according to a second color (and the corresponding lens has a corresponding color filter). With polarized glasses, images are presented for each eye using orthogonal polarizations, and each lens of the eyewear has the corresponding orthogonal polarization for receiving the corresponding image. With shutter glasses, each lens is synchronized with respect to left and right eye images provided by the display(s) 150, e.g., in alternating fashion. The display may provide both polarizations simultaneously or in an alternating manner (e.g., sequentially), as desired. Thus, the left eye may be allowed to only see left eye images during the left eye image display time and the right eye may be allowed to only see right eye images during the right eye image display time. With lenticular glasses, images form on cylindrical lens elements or a two-dimensional array of lens elements. The stereoscopic image may be provided via optical methods, where left and right eye images are provided only to the corresponding eyes using optical means such as prisms, mirror(s), lens(es), and the like. Large convex or concave lenses can also be used to receive two separately projected images to the user.

In some instances, eyewear 140 may be used as a position input device to track the user view (e.g., eyepoint or point of view (POV)) of a user viewing a 3D scene presented by the system 100A. For example, eyewear 140 may provide information (e.g., position information, which includes orientation information, etc.) that is usable to determine the position of the point of view of the user, e.g., via triangulation. In some instances, the position input device may use a light sensitive detection system, e.g., may include an infrared detection system, to detect the position of the viewer's head to allow the viewer freedom of head movement. Other instances of the input device(s) may use the triangulation method of detecting the viewer point of view location, such as one or more sensors (e.g., two cameras, such as charge coupled-device (CCD) or complementary metal oxide semiconductor (CMOS) cameras) providing position data suitable for the head tracking. The input device(s), such as a stylus, keyboard, mouse, trackball, joystick, or the like, or combinations thereof, may be manually operated by the viewer to specify or indicate the correct display of the horizontal perspective display images. However, any method for tracking the position of the user's head or point of view may be used as desired. Accordingly, the 3D scene may be rendered from the perspective (or point of view) of the user such that the user may view the 3D scene with minimal distortions (e.g., since it is based on the point of view of the user). Thus, the 3D scene may be particularly rendered for the point of view of the user, using the position input device.

The relationships among the position of the display(s) 150 and the point of view of the user may be used to map a portion of the virtual space to the physical space of the system 100A. In essence, the physical space and components used may be mapped to the virtual model in order to accurately render a 3D scene of the virtual space.

One or more of the user input devices (e.g., the keyboard 120, the mouse 125, the user input device 130, pointing device, user control device, user hand/fingers, etc.) may be used to interact with the presented 3D scene. For example, the user input device 130 (shown as a stylus) or simply the user's hands may be used to directly interact with virtual objects of the 3D scene (via the viewed projected objects). Such direct interaction may be possible with negative space portions of the 3D scene. In some instances, at least a portion of the 3D scene may be presented in this negative space, which is in front of or otherwise outside of the at least one display, via stereoscopic rendering (of the 3D scene). In some instances, at least a portion of the 3D scene may appear as a hologram-like image above the surface of the display 150. For example, when the horizontal display 150B is used, the 3D scene may be seen as hovering above the horizontal display. It should be noted, however, that a portion of the 3D scene may also be presented as appearing behind the display surface, which is in positive space Thus, negative space refers to a space which the user is able to freely move in and interact with (e.g., where the user is able to place his hands (or more generally, user input device 130) in the space), as opposed to a space the user cannot freely move in and interact with (e.g., where the user is not able to place his hands (or a user input device 130) in the space, such as below the display surface). Thus, negative space may be considered to be a “hands-on volume” as opposed to an “inner-volume” (i.e., positive space), which may be under the surface of the display(s), and thus not accessible. Thus, the user may interact with virtual objects in the negative space because they are proximate to the user's own physical space. Said another way, the positive space is located behind (or under) the viewing surface, and so presented objects appear to be located inside (or on the back side of) the physical viewing device. Thus, objects of the 3D scene presented within the positive space do not share the same physical space with the user and the objects therefore cannot be directly and physically manipulated by hands or physically intersected by hand-held tools such as user input device 130. Rather, they may be manipulated indirectly, e.g., via a computer mouse, a joystick, virtual representations of hands, handheld tools, or a stylus, or by projections from the stylus (e.g., a virtual laser or a virtual plane).

In some instances, system 100A may include one or more sensors 160. The one or more sensors 160 may be included in a tracking system. FIG. 1A illustrates an instance using four cameras 160. For instance, two of the four cameras 160 may be used to sense a user view (e.g., point of view) and the other two cameras 160 may be used to sense a user input device (e.g., pointing device, stylus, hand, glove, etc.). Alternatively, fewer than four sensors may be used (e.g., two sensors), wherein each sensor may track both the user (e.g., the user's head and/or the user's point of view) and the user input device. Sensors 160 may be used to image a user of system 100A, track a user's movement, or track a user's head or eyes, among other contemplated functions. In one instance, cameras 160 may track a position and/or an orientation of user input device 130. The information regarding the position (including the orientation) of the user input device 130 provided by the one or more sensors 160 may be used to perform 3D tracking of the user input device 130. The one or more sensors 160 may be spatially separated from one another and placed in a position to view a volume that encompasses where a user will view stereo imagery. Sensors 160 may also be far enough apart from each other to provide for a separation of view for a true three-axis triangulation determination. System 100A may also include a caddy 170 to store user input device 130. Caddy 170 may also be used to calibrate the orientation of the stylus to a known roll, pitch, and yaw, and so may be in a fixed position relative to cameras 160.

In some instances, the system 100A may be configured to couple to a network, such as a wide area network, via an input. The input may be configured to receive data (e.g., image data, video data, audio data, etc.) over the network from a system similar to system 100A. In other instances, a tracking system may include cameras 160. Cameras 160 may be configured to provide visual information regarding a user (e.g., such that a POV, e.g., the position (including the orientation), of the user may be determined or such that a position of the user's hand may be determined). However, it should be noted that any type of various tracking techniques or devices may be used as desired. Note that as used herein, POV of a user refers to the perspective or POV from which a user optically views an object or image, i.e., a user's visual POV, and thus is defined with respect to the display device of the system. In some instances, the POV may be a 6 degree of freedom (6DOF) POV, e.g., three location coordinates and three orientation coordinates, although any POV may be used as desired, e.g., three location coordinates and two or three orientation coordinates, and so forth. As noted above, position coordinates may include both location and orientation coordinates.

Note that in some instances, the tracking system may rely at least in part on the components of chassis 110A to determine a position or a POV, e.g., via execution of one more programs by or on a processor or functional unit of chassis 110A, although in other instances the tracking system may operate independently, e.g., may have its own processor or functional unit.

In certain instances, the system may include components implementing a perspective-based image capture system, for capturing images of a target object at a location remote from the system. For example, the perspective-based image capture system may include an input configured to couple to a network for receiving information regarding a point of view (POV) from a tracking system at a remote location. The information regarding the POV may indicate a position of a remote user. The perspective-based image capture system may further include another image capture system for capturing images of a target object. More specifically, the image capture system may be configured to capture one or more images from a first perspective based on the information regarding the POV received by the input.

The user may be able to specify or otherwise manipulate a virtual viewpoint within the 3D scene presented by the display(s) 150. A view of the 3D scene may be presented based on the virtual viewpoint, either by one or more of the display(s) 150 or another display, as desired. This view of the 3D scene may be stereoscopic or monoscopic, as desired.

A 3D scene generator (e.g., content processing system) stored and executed in the chassis 110A may be configured to dynamically change the displayed images provided by the display(s) 150. More particularly, the 3D scene generator may update the displayed 3D scene based on changes in the user view, user control (e.g., manipulations via the user input devices), etc. Such changes may be performed dynamically at run-time, and may be performed in real time. The 3D scene generator may also keep track of peripheral devices (e.g., user input device 130 or eyewear 140) to ensure synchronization between the peripheral device and the displayed image. The system may further include a calibration unit, procedure, and/or fiducial markers to ensure proper mapping of the peripheral device to the display images and proper mapping between the projected images and the virtual images stored in the memory of the chassis 110A.

Thus, the system 100A may present a 3D scene with which the user may interact in real time. The system may include real-time electronic display(s) 150 that may present or convey perspective images in the open space, and user input device 130 that may allow the user to interact with the 3D scene with hand controlled or hand-held tools. The system 100A may also include means to manipulate the displayed image in various ways, such as magnification, zoom, rotation, or movement, or even to display a new image. However, as noted above, in some instances, the system may facilitate such manipulations via the user's hands, e.g., without hand-held tools.

Further, while the system 100A is shown as including horizontal display 150B because it simulates the user's visual experience with the horizontal ground, other viewing surfaces may offer similar 3D illusion experiences. For example, the 3D scene may appear to be hanging from a ceiling by projecting the horizontal perspective images onto a ceiling surface, or may appear to be floating from a wall by projecting horizontal perspective images onto a vertical wall surface. More generally, any other variations in display orientation and perspective (or any other configuration of the system 100A) may be used as desired.

According to various embodiments of the present disclosure, the display 150 may display various types of information (for example, multimedia data or text data) to be provided to the user. The display 150 may be configured to include a liquid crystal display (LCD), a light emitting diode (LED) display, an organic LED (OLED) display, a plasma cell display, an electronic ink array display, an electronic paper display, a flexible LCD, a flexible electrochromic display, or a flexible electro wetting display. The display 150 may be connected functionally to an element(s) of the electronic device. Also, the display 150 may be connected functionally to an electronic device(s) other than the electronic device.

In the example of FIG. 1B, computer system 100B may include chassis 110B which may include display 150, keyboard 120, trackpad or touchpad 135, and at least two cameras 160. The computer system 100B may also include user input device 130. Further, the computer system 100B may optionally include eyewear 140. Note that in some instances, computer system 100B may be a wireless or mobile station, e.g., such as a wireless station 106 further described below. For example, computer system 100B may be or included on mobile telephones or smart phones (e.g., iPhone™, Android™-based phones), tablet computers (e.g., iPad™, Samsung Galaxy™, etc.), laptop computers (e.g., MacBook™), portable gaming devices (e.g., Nintendo DS™, PlayStation Portable™ Gameboy Advance™, iPhone™), portable Internet devices, and/or other handheld devices. In various instances, at least one of the display 150 may be a stereoscopic display. It is noted that a stereoscopic display may also be configured to display two-dimensional (2D) objects and may be configured to operate in a 2D mode.

The chassis 110B may include various computer components such as processors, at least one memory medium (e.g., RAM, ROM, hard drives, etc.), graphics circuitry, audio circuitry, and other circuitry for performing computer tasks, such as those described herein. The at least one memory medium may store one or more computer programs or software components according to various instances of the present invention. For example, the memory medium may store one or more graphics engines which are executable to perform some of the techniques described herein. In certain instances, the graphics engine may be implemented on or by a functional unit or processing element. As used herein, and as noted in the Terms section above, the term functional unit or processing element refers to any of various elements or combinations of elements configured to process instructions and/or data. Processing elements include, for example, circuits such as an ASIC (Application Specific Integrated Circuit), portions or circuits of individual processor cores, entire processor cores, individual processors, programmable hardware devices such as a field programmable gate array (FPGA), and/or larger portions of systems that include multiple processors, as well as any combinations thereof.

The memory medium (which may include two or more memory mediums) may also store data (and/or program instructions) (e.g., implementing or specifying a computer model) representing a virtual space, which may be used for projecting a 3D scene, such as scene 180, of the virtual space via the display(s) 150. Further, the memory medium may store software which is executable to perform three-dimensional spatial tracking (e.g., user view tracking, user control tracking, etc.), content processing, or other features, as described herein. For example, the computer system may include a tracking system that may track one or more of a user's head, a user's hand, or the stylus. Additionally, the memory medium may store operating system software, as well as other software for operation of the computer system. Various instances further include receiving or storing instructions and/or data implemented in accordance with the foregoing description upon a carrier medium.

As indicated above, the computer system 100B (or more specifically, chassis 110B) may be configured to display a three-dimensional (3D) scene (e.g., via stereoscopic images), or 3D content, such as scene 180, using the display 150. The computer system 100B may also be configured to display a “view” of the 3D scene using the display 150. The “view” of the 3D scene, or content, may refer to a displayed portion of the 3D scene from a viewpoint within the 3D scene. A viewpoint within the 3D scene may be referred to as a “virtual viewpoint.” The view may be stereoscopic, e.g., may be displayed on a stereoscopic display. Alternatively, the view may be monoscopic (not stereoscopic), and may be displayed on either a monoscopic display or a stereoscopic display. Note that a monoscopic image or scene displayed on a stereoscopic display may appear the same as on a monoscopic display system.

In some instances, the display 150 may present a 3D scene for the user. This 3D scene may be considered or referred to as an illusion or simulated 3D because the actual provided images are 2D, but the scene is conveyed in 3D via the user's interpretation of the provided images via stereoscopic effects. In some instances, in order to properly view the stereoscopic images (one for each eye for each image frame), the user may wear eyewear 140. Eyewear 140 may be any of anaglyph glasses, polarized glasses, shutter glasses, lenticular glasses, etc., among others. In other instances, the stereoscopic images may be properly viewed without the aid of eyewear 140.

In some instances, eyewear 140 may be used as a position input device to track the user view (e.g., eyepoint or point of view (POV)) of a user viewing a 3D scene presented by the system 100B. For example, eyewear 140 may provide information (e.g., position information, which includes orientation information, etc.) that is usable to determine the position of the point of view of the user, e.g., via triangulation. In some instances, the position input device may use a light sensitive detection system, e.g., may include an infrared detection system, to detect the position of the viewer's head to allow the viewer freedom of head movement. Other instances of the input device(s) may use the triangulation method of detecting the viewer point of view location, such as one or more sensors (e.g., two cameras, such as charge coupled-device (CCD) or complementary metal oxide semiconductor (CMOS) cameras) providing position data suitable for the head tracking. The input device(s), such as a stylus, keyboard, mouse, trackball, joystick, or the like, or combinations thereof, may be manually operated by the viewer to specify or indicate the correct display of the horizontal perspective display images. However, any method for tracking the position of the user's head or point of view may be used as desired. Accordingly, the 3D scene may be rendered from the perspective (or point of view) of the user such that the user may view the 3D scene with minimal distortions (e.g., since it is based on the point of view of the user). Thus, the 3D scene may be particularly rendered for the point of view of the user, using the position input device.

The relationships among the position of the display 150 and the point of view of the user may be used to map a portion of the virtual space to the physical space of the system 100B. In essence, the physical space and components used may be mapped to the virtual model in order to accurately render a 3D scene of the virtual space.

One or more of the user input devices (e.g., the keyboard 120, the trackpad 135, the user input device 130, pointing device, user control device, user hand/fingers, etc.) may be used to interact with the presented 3D scene. For example, the user input device 130 (shown as a passive stylus) or simply the user's hands may be used to directly interact with virtual objects of the 3D scene (via the viewed projected objects). Such direct interaction may be possible with negative space portions of the 3D scene. In some instances, at least a portion of the 3D scene may be presented in this negative space, which is in front of or otherwise outside of the at least one display, via stereoscopic rendering (of the 3D scene). In some instances, at least a portion of the 3D scene may appear as a hologram-like image above the surface of the display 150. It should be noted, however, that a portion of the 3D scene may also be presented as appearing behind the display surface, which is in positive space. Thus, negative space refers to a space which the user is able to freely move in and interact with (e.g., where the user is able to place his hands (or more generally, user input device 130) in the space), as opposed to a space the user cannot freely move in and interact with (e.g., where the user is not able to place his hands (or a user input device 130) in the space, such as below the display surface). Thus, negative space may be considered to be a “hands-on volume” as opposed to an “inner-volume” (i.e., positive space), which may be under the surface of the display(s), and thus not accessible. Thus, the user may interact with virtual objects in the negative space because they are proximate to the user's own physical space. Said another way, the positive space is located behind (or under) the viewing surface, and so presented objects appear to be located inside (or on the back side of) the physical viewing device. Thus, objects of the 3D scene presented within the positive space do not share the same physical space with the user and the objects therefore cannot be directly and physically manipulated by hands or physically intersected by hand-held tools such as user input device 130. Rather, they may be manipulated indirectly, e.g., via a computer mouse, a joystick, virtual representations of hands, handheld tools, or a stylus, or by projections from the stylus (e.g., a virtual laser or a virtual plane).

In some instances, system 100B may include one or more sensors 160. The one or more sensors 160 may be included in a tracking system. FIG. 1B illustrates an instance using four cameras 160. For instance, two of the four cameras 160 may be used to sense a user view (e.g., point of view) and the other two cameras 160 may be used to sense a user input device (e.g., pointing device, stylus, hand, glove, etc.). Alternatively, fewer than four sensors may be used (e.g., two sensors), wherein each sensor may track both the user (e.g., the user's head and/or the user's point of view) and the user input device. Sensors 160 may be used to image a user of system 100B, track a user's movement, or track a user's head or eyes, among other contemplated functions. In some instances, cameras 160 may track a position and/or an orientation of user input device 130. The information regarding the position (including the orientation) of the user input device 130 provided by the one or more sensors 160 may be used to perform 3D tracking of the user input device 130. The one or more sensors 160 may be spatially separated from one another and placed in a position to view a volume that encompasses where a user will view stereo imagery. Sensors 160 may also be far enough apart from each other to provide for a separation of view for a true three-axis triangulation determination.

In some instances, the system 100B may be configured to couple to a network, such as a wide area network, via an input or interface (wired or wireless). The input may be configured to receive data (e.g., image data, video data, audio data, etc.) over the network from a system similar to systems 100A or 100B. In other instances, a tracking system may include cameras 160. Cameras 160 may be configured to provide visual information regarding a user (e.g., such that a POV, e.g., the position (including the orientation), of the user may be determined or such that a position of the user's hand may be determined). However, it should be noted that any type of various tracking techniques or devices may be used as desired. Note that as used herein, POV of a user refers to the perspective or POV from which a user optically views an object or image, i.e., a user's visual POV, and thus is defined with respect to the display device of the system. In some instances, the POV may be a 6 degree of freedom (6DOF) POV, e.g., three location coordinates and three orientation coordinates, although any POV may be used as desired, e.g., three location coordinates and two or three orientation coordinates, and so forth. As noted above, position coordinates may include both location and orientation coordinates.

Note that in some instances, the tracking system may rely at least in part on the components of chassis 110B to determine a position or a POV, e.g., via execution of one more programs by or on a processor or functional unit of chassis 110B, although in other instances the tracking system may operate independently, e.g., may have its own processor or functional unit.

In certain instances, the system may include components implementing a perspective-based image capture system, for capturing images of a target object at a location remote from the system. For example, the perspective-based image capture system may include an input configured to couple to a network for receiving information regarding a point of view (POV) from a tracking system at a remote location. The information regarding the POV may indicate a position of a remote user. The perspective-based image capture system may further include another image capture system for capturing images of a target object. More specifically, the image capture system may be configured to capture one or more images from a first perspective based on the information regarding the POV received by the input.

The user may be able to specify or otherwise manipulate a virtual viewpoint within the 3D scene presented by the display 150. A view of the 3D scene may be presented based on the virtual viewpoint, either by one or more of the display 150 or another display, as desired. This view of the 3D scene may be stereoscopic or monoscopic, as desired.

A 3D scene generator (e.g., content processing system) stored and executed in the chassis 110B may be configured to dynamically change the displayed images provided by the display 150. More particularly, the 3D scene generator may update the displayed 3D scene based on changes in the user view, user control (e.g., manipulations via the user input devices), etc. Such changes may be performed dynamically at run-time, and may be performed in real time. The 3D scene generator may also keep track of peripheral devices (e.g., user input device 130 or eyewear 140) to ensure synchronization between the peripheral device and the displayed image. The system may further include a calibration unit, procedure, and/or fiducial markers to ensure proper mapping of the peripheral device to the display images and proper mapping between the projected images and the virtual images stored in the memory of the chassis 110B.

Thus, the system 100B may present a 3D scene with which the user may interact in real time. The system may include real-time electronic display 150 that may present or convey perspective images in the open space, and user input device 130 that may allow the user to interact with the 3D scene with hand controlled or hand-held tools. The system 100B may also include means to manipulate the displayed image in various ways, such as magnification, zoom, rotation, or movement, or even to display a new image. However, as noted above, in some instances, the system may facilitate such manipulations via the user's hands, e.g., without hand-held tools.

According to various embodiments of the present disclosure, the display 150 may display various types of information (for example, multimedia data or text data) to be provided to the user. The display 150 may be configured to include a liquid crystal display (LCD), a light emitting diode (LED) display, an organic LED (OLED) display, a plasma cell display, an electronic ink array display, an electronic paper display, a flexible LCD, a flexible electrochromic display, or a flexible electro wetting display. The display 150 may be connected functionally to an element(s) of the electronic device. Also, the display 150 may be connected functionally to an electronic device(s) other than the electronic device. According to various embodiments of the present disclosure, the input module 240 may receive an input for controlling an attribute of, for example, a history screen. The input module 240 may receive, for example, an input of ‘reference screen setting’. ‘Reference screen setting’ may involve an operation for storing information related to the screen in the storage module 210 in order to display the reference screen. The input module 240 may receive, for example, an input for displaying the reference screen. Attributes of the screen may include, for example, at least one of the position of the reference screen, a sound volume for the reference screen, brightness of the screen, and the size of the screen. If the input module 240 is included in a second electronic device, the input module 240 may not be provided in the electronic device according to various embodiments of the present disclosure.

In the example of FIG. 1C, computer system 100C may include chassis 110C which may include display 150, keyboard 120, trackpad or touchpad 135, a keyboard/chassis facing camera 175, and at least two cameras 160. The computer system 100C may also include user input device 130. Further, the computer system 100C may optionally include eyewear 140. Note that in some instances, computer system 100C may be a wireless or mobile station, e.g., such as a wireless station 106 further described below. For example, computer system 100C may be or included on mobile telephones or smart phones (e.g., iPhone™, Android™-based phones), tablet computers (e.g., iPad™, Samsung Galaxy™, etc.), laptop computers (e.g., MacBook™), portable gaming devices (e.g., Nintendo DS™, PlayStation Portable™, Gameboy Advance™, iPhone™), portable Internet devices, and/or other handheld devices. In various instances, at least one of the display 150 may be a stereoscopic display. It is noted that a stereoscopic display may also be configured to display two-dimensional (2D) objects and may be configured to operate in a 2D mode.

The chassis 110C may include various computer components such as processors, at least one memory medium (e.g., RAM, ROM, hard drives, etc.), graphics circuitry, audio circuitry, and other circuitry for performing computer tasks, such as those described herein. The at least one memory medium may store one or more computer programs or software components according to various instances of the present invention. For example, the memory medium may store one or more graphics engines which are executable to perform some of the techniques described herein. In certain instances, the graphics engine may be implemented on or by a functional unit or processing element. As used herein, and as noted in the Terms section above, the term functional unit or processing element refers to any of various elements or combinations of elements configured to process instructions and/or data. Processing elements include, for example, circuits such as an ASIC (Application Specific Integrated Circuit), portions or circuits of individual processor cores, entire processor cores, individual processors, programmable hardware devices such as a field programmable gate array (FPGA), and/or larger portions of systems that include multiple processors, as well as any combinations thereof.

The memory medium (which may include two or more memory mediums) may also store data (and/or program instructions) (e.g., implementing or specifying a computer model) representing a virtual space, which may be used for projecting a 3D scene, such as scene 180, of the virtual space via the display(s) 150. Further, the memory medium may store software which is executable to perform three-dimensional spatial tracking (e.g., user view tracking, user control tracking, etc.), content processing, or other features, as described herein. For example, the computer system may include a tracking system that may track one or more of a user's head, a user's hand, or the stylus. Additionally, the memory medium may store operating system software, as well as other software for operation of the computer system. Various instances further include receiving or storing instructions and/or data implemented in accordance with the foregoing description upon a carrier medium.

As indicated above, the computer system 100C (or more specifically, chassis 110C) may be configured to display a three-dimensional (3D) scene (e.g., via stereoscopic images), or 3D content, such as scene 180, using the display 150. The computer system 100C may also be configured to display a “view” of the 3D scene using the display 150. The “view” of the 3D scene, or content, may refer to a displayed portion of the 3D scene from a viewpoint within the 3D scene. A viewpoint within the 3D scene may be referred to as a “virtual viewpoint.” The view may be stereoscopic, e.g., may be displayed on a stereoscopic display. Alternatively, the view may be monoscopic (not stereoscopic), and may be displayed on either a monoscopic display or a stereoscopic display. Note that a monoscopic image or scene displayed on a stereoscopic display may appear the same as on a monoscopic display system.

In some instances, the display 150 may present a 3D scene for the user. This 3D scene may be considered or referred to as an illusion or simulated 3D because the actual provided images are 2D, but the scene is conveyed in 3D via the user's interpretation of the provided images via stereoscopic effects. In some instances, in order to properly view the stereoscopic images (one for each eye for each image frame), the user may wear eyewear 140. Eyewear 140 may be any of anaglyph glasses, polarized glasses, shutter glasses, lenticular glasses, etc., among others. In other instances, the stereoscopic images may be properly viewed without the aid of eyewear 140.

In some instances, eyewear 140 may be used as a position input device to track the user view (e.g., eyepoint or point of view (POV)) of a user viewing a 3D scene presented by the system 100C. For example, eyewear 140 may provide information (e.g., position information, which includes orientation information, etc.) that is usable to determine the position of the point of view of the user, e.g., via triangulation. In some instances, the position input device may use a light sensitive detection system, e.g., may include an infrared detection system, to detect the position of the viewer's head to allow the viewer freedom of head movement. Other instances of the input device(s) may use the triangulation method of detecting the viewer point of view location, such as one or more sensors (e.g., two cameras, such as charge coupled-device (CCD) or complementary metal oxide semiconductor (CMOS) cameras) providing position data suitable for the head tracking. The input device(s), such as a stylus, keyboard, mouse, trackball, joystick, or the like, or combinations thereof, may be manually operated by the viewer to specify or indicate the correct display of the horizontal perspective display images. However, any method for tracking the position of the user's head or point of view may be used as desired. Accordingly, the 3D scene may be rendered from the perspective (or point of view) of the user such that the user may view the 3D scene with minimal distortions (e.g., since it is based on the point of view of the user). Thus, the 3D scene may be particularly rendered for the point of view of the user, using the position input device.

The relationships among the position of the display 150 and the point of view of the user may be used to map a portion of the virtual space to the physical space of the system 100C. In essence, the physical space and components used may be mapped to the virtual model in order to accurately render a 3D scene of the virtual space.

One or more of the user input devices (e.g., the keyboard 120, the trackpad 135, the user input device 130, pointing device, user control device, user hand/fingers, etc.) may be used to interact with the presented 3D scene. For example, the user input device 130 (shown as a passive stylus) or simply the user's hands may be used to directly interact with virtual objects of the 3D scene (via the viewed projected objects). Such direct interaction may be possible with negative space portions of the 3D scene. In some instances, at least a portion of the 3D scene may be presented in this negative space, which is in front of or otherwise outside of the at least one display, via stereoscopic rendering (of the 3D scene). In some instances, at least a portion of the 3D scene may appear as a hologram-like image above the surface of the display 150. It should be noted, however, that a portion of the 3D scene may also be presented as appearing behind the display surface, which is in positive space. Thus, negative space refers to a space which the user is able to freely move in and interact with (e.g., where the user is able to place his hands (or more generally, user input device 130) in the space), as opposed to a space the user cannot freely move in and interact with (e.g., where the user is not able to place his hands (or a user input device 130) in the space, such as below the display surface). Thus, negative space may be considered to be a “hands-on volume” as opposed to an “inner-volume” (i.e., positive space), which may be under the surface of the display(s), and thus not accessible. Thus, the user may interact with virtual objects in the negative space because they are proximate to the user's own physical space. Said another way, the positive space is located behind (or under) the viewing surface, and so presented objects appear to be located inside (or on the back side of) the physical viewing device. Thus, objects of the 3D scene presented within the positive space do not share the same physical space with the user and the objects therefore cannot be directly and physically manipulated by hands or physically intersected by hand-held tools such as user input device 130. Rather, they may be manipulated indirectly, e.g., via a computer mouse, a joystick, virtual representations of hands, handheld tools, or a stylus, or by projections from the stylus (e.g., a virtual laser or a virtual plane).

In some instances, system 100C may include one or more sensors 160. The one or more sensors 160 may be included in a tracking system. FIG. 1C illustrates an instance using four cameras 160. For instance, two of the four cameras 160 may be used to sense a user view (e.g., point of view) and the other two cameras 160 may be used to sense a user input device (e.g., pointing device, stylus, hand, glove, etc.). Alternatively, fewer than four sensors may be used (e.g., two sensors), wherein each sensor may track both the user (e.g., the user's head and/or the user's point of view) and the user input device. Sensors 160 may be used to image a user of system 100C, track a user's movement, or track a user's head or eyes, among other contemplated functions. In some instances, cameras 160 may track a position and/or an orientation of user input device 130. The information regarding the position (including the orientation) of the user input device 130 provided by the one or more sensors 160 may be used to perform 3D tracking of the user input device 130. The one or more sensors 160 may be spatially separated from one another and placed in a position to view a volume that encompasses where a user will view stereo imagery. Sensors 160 may also be far enough apart from each other to provide for a separation of view for a true three-axis triangulation determination.

In some instances, the system 100C may be configured to couple to a network, such as a wide area network, via an input or interface (wired or wireless). The input may be configured to receive data (e.g., image data, video data, audio data, etc.) over the network from a system similar to systems 100A or 100C. In other instances, a tracking system may include cameras 160. Cameras 160 may be configured to provide visual information regarding a user (e.g., such that a POV, e.g., the position (including the orientation), of the user may be determined or such that a position of the user's hand may be determined). However, it should be noted that any type of various tracking techniques or devices may be used as desired. Note that as used herein, POV of a user refers to the perspective or POV from which a user optically views an object or image, i.e., a user's visual POV, and thus is defined with respect to the display device of the system. In some instances, the POV may be a 6 degree of freedom (6DOF) POV, e.g., three location coordinates and three orientation coordinates, although any POV may be used as desired, e.g., three location coordinates and two or three orientation coordinates, and so forth. As noted above, position coordinates may include both location and orientation coordinates.

Note that in some instances, the tracking system may rely at least in part on the components of chassis 110C to determine a position or a POV, e.g., via execution of one more programs by or on a processor or functional unit of chassis 110C, although in other instances the tracking system may operate independently, e.g., may have its own processor or functional unit.

In certain instances, the system may include components implementing a perspective-based image capture system, for capturing images of a target object at a location remote from the system. For example, the perspective-based image capture system may include an input configured to couple to a network for receiving information regarding a point of view (POV) from a tracking system at a remote location. The information regarding the POV may indicate a position of a remote user. The perspective-based image capture system may further include another image capture system for capturing images of a target object. More specifically, the image capture system may be configured to capture one or more images from a first perspective based on the information regarding the POV received by the input.

The user may be able to specify or otherwise manipulate a virtual viewpoint within the 3D scene presented by the display 150. A view of the 3D scene may be presented based on the virtual viewpoint, either by one or more of the display 150 or another display, as desired. This view of the 3D scene may be stereoscopic or monoscopic, as desired.

A 3D scene generator (e.g., content processing system) stored and executed in the chassis 110C may be configured to dynamically change the displayed images provided by the display 150. More particularly, the 3D scene generator may update the displayed 3D scene based on changes in the user view, user control (e.g., manipulations via the user input devices), etc. Such changes may be performed dynamically at run-time, and may be performed in real time. The 3D scene generator may also keep track of peripheral devices (e.g., user input device 130 or eyewear 140) to ensure synchronization between the peripheral device and the displayed image. The system may further include a calibration unit, procedure, and/or fiducial markers to ensure proper mapping of the peripheral device to the display images and proper mapping between the projected images and the virtual images stored in the memory of the chassis 110C.

Thus, the system 100C may present a 3D scene with which the user may interact in real time. The system may include real-time electronic display 150 that may present or convey perspective images in the open space, and user input device 130 that may allow the user to interact with the 3D scene with hand controlled or hand-held tools. The system 100C may also include means to manipulate the displayed image in various ways, such as magnification, zoom, rotation, or movement, or even to display a new image. However, as noted above, in some instances, the system may facilitate such manipulations via the user's hands, e.g., without hand-held tools.

According to various embodiments of the present disclosure, the display 150 may display various types of information (for example, multimedia data or text data) to be provided to the user. The display 150 may be configured to include a liquid crystal display (LCD), a light emitting diode (LED) display, an organic LED (OLED) display, a plasma cell display, an electronic ink array display, an electronic paper display, a flexible LCD, a flexible electrochromic display, or a flexible electro wetting display. The display 150 may be connected functionally to an element(s) of the electronic device. Also, the display 150 may be connected functionally to an electronic device(s) other than the electronic device. According to various embodiments of the present disclosure, the input module 240 may receive an input for controlling an attribute of, for example, a history screen. The input module 240 may receive, for example, an input of ‘reference screen setting’. ‘Reference screen setting’ may involve an operation for storing information related to the screen in the storage module 210 in order to display the reference screen. The input module 240 may receive, for example, an input for displaying the reference screen. Attributes of the screen may include, for example, at least one of the position of the reference screen, a sound volume for the reference screen, brightness of the screen, and the size of the screen. If the input module 240 is included in a second electronic device, the input module 240 may not be provided in the electronic device according to various embodiments of the present disclosure.

In some instances, chassis 110C may include one or more cameras 175. The one or more cameras 175 may be configured and/or positioned to have an oblique view of a portion of the chassis 110C, such as a portion of the keyboard 120. According to various embodiments further described herein, the system 100C may be configured to determine an angle of the display 150 relative to the keyboard 120 based, at least in part, on images obtained via the one or more cameras 175. Note that the one or more cameras 175 may be configured as a wide-angle camera, a fish-eye lenses camera, a monochromatic camera, and so forth. The portion of the chassis 110C may include a region of interest, at least in some instances. In some instances, the region of interest may be a portion of the keyboard 120. In other instances, the region of interest may include distinguishing marks, patterns, imprints, and so forth to aid in detection of movement of the display 150 relative to the keyboard 120.

In the example of FIG. 1D, computer system 100D may include chassis 110D which may include display 150, keyboard 120, trackpad or touchpad 135, a keyboard/chassis facing camera 175, and at least two cameras 160. The computer system 100D may also include user input device 130. Further, the computer system 100D may optionally include eyewear 140. Note that in some instances, computer system 100D may be a wireless or mobile station, e.g., such as a wireless station 106 further described below. For example, computer system 100D may be or included on mobile telephones or smart phones (e.g., iPhone™, Android™-based phones), tablet computers (e.g., iPad™, Samsung Galaxy™, etc.), laptop computers (e.g., MacBook™), portable gaming devices (e.g., Nintendo DS™, PlayStation Portable™, Gameboy Advance™, iPhone™), portable Internet devices, and/or other handheld devices. In various instances, at least one of the display 150 may be a stereoscopic display. It is noted that a stereoscopic display may also be configured to display two-dimensional (2D) objects and may be configured to operate in a 2D mode.

The chassis 110D may include various computer components such as processors, at least one memory medium (e.g., RAM, ROM, hard drives, etc.), graphics circuitry, audio circuitry, and other circuitry for performing computer tasks, such as those described herein. The at least one memory medium may store one or more computer programs or software components according to various instances of the present invention. For example, the memory medium may store one or more graphics engines which are executable to perform some of the techniques described herein. In certain instances, the graphics engine may be implemented on or by a functional unit or processing element. As used herein, and as noted in the Terms section above, the term functional unit or processing element refers to any of various elements or combinations of elements configured to process instructions and/or data. Processing elements include, for example, circuits such as an ASIC (Application Specific Integrated Circuit), portions or circuits of individual processor cores, entire processor cores, individual processors, programmable hardware devices such as a field programmable gate array (FPGA), and/or larger portions of systems that include multiple processors, as well as any combinations thereof.

The memory medium (which may include two or more memory mediums) may also store data (and/or program instructions) (e.g., implementing or specifying a computer model) representing a virtual space, which may be used for projecting a 3D scene, such as scene 180, of the virtual space via the display(s) 150. Further, the memory medium may store software which is executable to perform three-dimensional spatial tracking (e.g., user view tracking, user control tracking, etc.), content processing, or other features, as described herein. For example, the computer system may include a tracking system that may track one or more of a user's head, a user's hand, or the stylus. Additionally, the memory medium may store operating system software, as well as other software for operation of the computer system. Various instances further include receiving or storing instructions and/or data implemented in accordance with the foregoing description upon a carrier medium.

As indicated above, the computer system 100D (or more specifically, chassis 110D) may be configured to display a three-dimensional (3D) scene (e.g., via stereoscopic images), or 3D content, such as scene 180, using the display 150. The computer system 100D may also be configured to display a “view” of the 3D scene using the display 150. The “view” of the 3D scene, or content, may refer to a displayed portion of the 3D scene from a viewpoint within the 3D scene. A viewpoint within the 3D scene may be referred to as a “virtual viewpoint.” The view may be stereoscopic, e.g., may be displayed on a stereoscopic display. Alternatively, the view may be monoscopic (not stereoscopic), and may be displayed on either a monoscopic display or a stereoscopic display. Note that a monoscopic image or scene displayed on a stereoscopic display may appear the same as on a monoscopic display system.

In some instances, the display 150 may present a 3D scene for the user. This 3D scene may be considered or referred to as an illusion or simulated 3D because the actual provided images are 2D, but the scene is conveyed in 3D via the user's interpretation of the provided images via stereoscopic effects. In some instances, in order to properly view the stereoscopic images (one for each eye for each image frame), the user may wear eyewear 140. Eyewear 140 may be any of anaglyph glasses, polarized glasses, shutter glasses, lenticular glasses, etc., among others. In other instances, the stereoscopic images may be properly viewed without the aid of eyewear 140.

In some instances, eyewear 140 may be used as a position input device to track the user view (e.g., eyepoint or point of view (POV)) of a user viewing a 3D scene presented by the system 100D. For example, eyewear 140 may provide information (e.g., position information, which includes orientation information, etc.) that is usable to determine the position of the point of view of the user, e.g., via triangulation. In some instances, the position input device may use a light sensitive detection system, e.g., may include an infrared detection system, to detect the position of the viewer's head to allow the viewer freedom of head movement. Other instances of the input device(s) may use the triangulation method of detecting the viewer point of view location, such as one or more sensors (e.g., two cameras, such as charge coupled-device (CCD) or complementary metal oxide semiconductor (CMOS) cameras) providing position data suitable for the head tracking. The input device(s), such as a stylus, keyboard, mouse, trackball, joystick, or the like, or combinations thereof, may be manually operated by the viewer to specify or indicate the correct display of the horizontal perspective display images. However, any method for tracking the position of the user's head or point of view may be used as desired. Accordingly, the 3D scene may be rendered from the perspective (or point of view) of the user such that the user may view the 3D scene with minimal distortions (e.g., since it is based on the point of view of the user). Thus, the 3D scene may be particularly rendered for the point of view of the user, using the position input device.

The relationships among the position of the display 150 and the point of view of the user may be used to map a portion of the virtual space to the physical space of the system 100D. In essence, the physical space and components used may be mapped to the virtual model in order to accurately render a 3D scene of the virtual space.

One or more of the user input devices (e.g., the keyboard 120, the trackpad 135, the user input device 130, pointing device, user control device, user hand/fingers, etc.) may be used to interact with the presented 3D scene. For example, the user input device 130 (shown as a passive stylus) or simply the user's hands may be used to directly interact with virtual objects of the 3D scene (via the viewed projected objects). Such direct interaction may be possible with negative space portions of the 3D scene. In some instances, at least a portion of the 3D scene may be presented in this negative space, which is in front of or otherwise outside of the at least one display, via stereoscopic rendering (of the 3D scene). In some instances, at least a portion of the 3D scene may appear as a hologram-like image above the surface of the display 150. It should be noted, however, that a portion of the 3D scene may also be presented as appearing behind the display surface, which is in positive space. Thus, negative space refers to a space which the user is able to freely move in and interact with (e.g., where the user is able to place his hands (or more generally, user input device 130) in the space), as opposed to a space the user cannot freely move in and interact with (e.g., where the user is not able to place his hands (or a user input device 130) in the space, such as below the display surface). Thus, negative space may be considered to be a “hands-on volume” as opposed to an “inner-volume” (i.e., positive space), which may be under the surface of the display(s), and thus not accessible. Thus, the user may interact with virtual objects in the negative space because they are proximate to the user's own physical space. Said another way, the positive space is located behind (or under) the viewing surface, and so presented objects appear to be located inside (or on the back side of) the physical viewing device. Thus, objects of the 3D scene presented within the positive space do not share the same physical space with the user and the objects therefore cannot be directly and physically manipulated by hands or physically intersected by hand-held tools such as user input device 130. Rather, they may be manipulated indirectly, e.g., via a computer mouse, a joystick, virtual representations of hands, handheld tools, or a stylus, or by projections from the stylus (e.g., a virtual laser or a virtual plane).

In some instances, system 100D may include one or more sensors 160. The one or more sensors 160 may be included in a tracking system. FIG. 1D illustrates an instance using four cameras 160. For instance, two of the four cameras 160 may be used to sense a user view (e.g., point of view) and the other two cameras 160 may be used to sense a user input device (e.g., pointing device, stylus, hand, glove, etc.). Alternatively, fewer than four sensors may be used (e.g., two sensors), wherein each sensor may track both the user (e.g., the user's head and/or the user's point of view) and the user input device. Sensors 160 may be used to image a user of system 100D, track a user's movement, or track a user's head or eyes, among other contemplated functions. In some instances, cameras 160 may track a position and/or an orientation of user input device 130. The information regarding the position (including the orientation) of the user input device 130 provided by the one or more sensors 160 may be used to perform 3D tracking of the user input device 130. The one or more sensors 160 may be spatially separated from one another and placed in a position to view a volume that encompasses where a user will view stereo imagery. Sensors 160 may also be far enough apart from each other to provide for a separation of view for a true three-axis triangulation determination.

In some instances, the system 100D may be configured to couple to a network, such as a wide area network, via an input or interface (wired or wireless). The input may be configured to receive data (e.g., image data, video data, audio data, etc.) over the network from a system similar to systems 100A or 100D. In other instances, a tracking system may include cameras 160. Cameras 160 may be configured to provide visual information regarding a user (e.g., such that a POV, e.g., the position (including the orientation), of the user may be determined or such that a position of the user's hand may be determined). However, it should be noted that any type of various tracking techniques or devices may be used as desired. Note that as used herein, POV of a user refers to the perspective or POV from which a user optically views an object or image, i.e., a user's visual POV, and thus is defined with respect to the display device of the system. In some instances, the POV may be a 6 degree of freedom (6DOF) POV, e.g., three location coordinates and three orientation coordinates, although any POV may be used as desired, e.g., three location coordinates and two or three orientation coordinates, and so forth. As noted above, position coordinates may include both location and orientation coordinates.

Note that in some instances, the tracking system may rely at least in part on the components of chassis 110D to determine a position or a POV, e.g., via execution of one more programs by or on a processor or functional unit of chassis 110D, although in other instances the tracking system may operate independently, e.g., may have its own processor or functional unit.

In certain instances, the system may include components implementing a perspective-based image capture system, for capturing images of a target object at a location remote from the system. For example, the perspective-based image capture system may include an input configured to couple to a network for receiving information regarding a point of view (POV) from a tracking system at a remote location. The information regarding the POV may indicate a position of a remote user. The perspective-based image capture system may further include another image capture system for capturing images of a target object. More specifically, the image capture system may be configured to capture one or more images from a first perspective based on the information regarding the POV received by the input.

The user may be able to specify or otherwise manipulate a virtual viewpoint within the 3D scene presented by the display 150. A view of the 3D scene may be presented based on the virtual viewpoint, either by one or more of the display 150 or another display, as desired. This view of the 3D scene may be stereoscopic or monoscopic, as desired.

A 3D scene generator (e.g., content processing system) stored and executed in the chassis 110D may be configured to dynamically change the displayed images provided by the display 150. More particularly, the 3D scene generator may update the displayed 3D scene based on changes in the user view, user control (e.g., manipulations via the user input devices), etc. Such changes may be performed dynamically at run-time, and may be performed in real time. The 3D scene generator may also keep track of peripheral devices (e.g., user input device 130 or eyewear 140) to ensure synchronization between the peripheral device and the displayed image. The system may further include a calibration unit, procedure, and/or fiducial markers to ensure proper mapping of the peripheral device to the display images and proper mapping between the projected images and the virtual images stored in the memory of the chassis 110D.

Thus, the system 100D may present a 3D scene with which the user may interact in real time. The system may include real-time electronic display 150 that may present or convey perspective images in the open space, and user input device 130 that may allow the user to interact with the 3D scene with hand controlled or hand-held tools. The system 100D may also include means to manipulate the displayed image in various ways, such as magnification, zoom, rotation, or movement, or even to display a new image. However, as noted above, in some instances, the system may facilitate such manipulations via the user's hands, e.g., without hand-held tools.

According to various embodiments of the present disclosure, the display 150 may display various types of information (for example, multimedia data or text data) to be provided to the user. The display 150 may be configured to include a liquid crystal display (LCD), a light emitting diode (LED) display, an organic LED (OLED) display, a plasma cell display, an electronic ink array display, an electronic paper display, a flexible LCD, a flexible electrochromic display, or a flexible electro wetting display. The display 150 may be connected functionally to an element(s) of the electronic device. Also, the display 150 may be connected functionally to an electronic device(s) other than the electronic device. According to various embodiments of the present disclosure, the input module 240 may receive an input for controlling an attribute of, for example, a history screen. The input module 240 may receive, for example, an input of ‘reference screen setting’. ‘Reference screen setting’ may involve an operation for storing information related to the screen in the storage module 210 in order to display the reference screen. The input module 240 may receive, for example, an input for displaying the reference screen. Attributes of the screen may include, for example, at least one of the position of the reference screen, a sound volume for the reference screen, brightness of the screen, and the size of the screen. If the input module 240 is included in a second electronic device, the input module 240 may not be provided in the electronic device according to various embodiments of the present disclosure.

In some instances, chassis 110D may include one or more cameras 185. The one or more cameras 185 may be configured and/or positioned to have an oblique view of a portion of the display 185. According to various embodiments further described herein, the system 100D may be configured to determine an angle of the display 150 relative to the keyboard 120 based, at least in part, on images obtained via the one or more cameras 185. Note that the one or more cameras 185 may be configured as a wide-angle camera, a fish-eye lenses camera, a monochromatic camera, and so forth. The portion of the display 150 may include a region of interest, at least in some instances. In some instances, the region of interest may be a corner of the display 150. In other instances, the region of interest may include distinguishing marks, patterns, imprints, and so forth to aid in detection of movement of the display 150 relative to the keyboard 120.

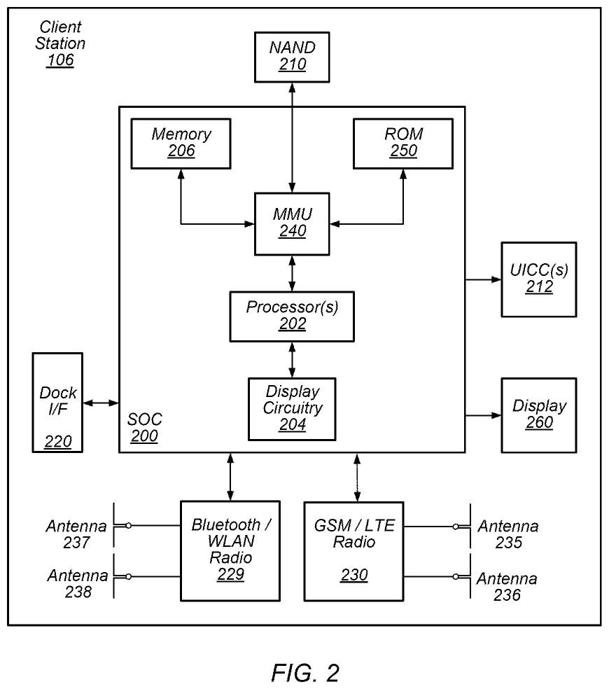

FIG. 2 illustrates an example simplified block diagram of a wireless station 106. According to embodiments, wireless station 106 may be a user equipment (UE) device, a mobile device and/or mobile station. Wireless station 106 may be used in conjunction with the systems described herein, such as systems 100A, 100B, 100C, and/or 100D as described herein. For example, wireless station 106 may be configured as an input device to any of the described systems (e.g., wireless station 106 may be configured as a user input device). As another example, according to some embodiments, wireless station 106 may be configured as a display of any of the described systems. Thus, wireless station 106 may be configured to display a stereoscopic image. In some embodiments, wireless station 106 may be configured to communicate with a 3D system either wirelessly (e.g., via a local area network such as a Wi-Fi, Bluetooth, or Bluetooth low energy connection) or via a wired interface such as a universal serial bus interface, among other wired interfaces. In some embodiments, wireless station 106 may be included in a computer system, such as computer systems 100B, 100C, and/or 100D described above.

As shown, the wireless station 106 may include a system on chip (SOC) 200, which may include portions for various purposes. The SOC 200 may be coupled to various other circuits of the wireless station 106. For example, the wireless station 106 may include various types of memory (e.g., including NAND flash 210), a connector interface (I/F) (or dock) 220 (e.g., for coupling to a computer system, dock, charging station, and/or for allowing auxiliary devices, such as device 400 described herein to interface/connect/dock with wireless station 106, etc.), the display 260, cellular communication circuitry 230 such as for LTE, GSM, etc., and short to medium range wireless communication circuitry 229 (e.g., Bluetooth™ and WLAN circuitry). The wireless station 106 may further include one or more smart cards 212 that incorporate SIM (Subscriber Identity Module) functionality, such as one or more UICC(s) (Universal Integrated Circuit Card(s)) cards 245. The cellular communication circuitry 230 may couple to one or more antennas, such as antennas 235 and 236 as shown. The short to medium range wireless communication circuitry 229 may also couple to one or more antennas, such as antennas 237 and 238 as shown. Alternatively, the short to medium range wireless communication circuitry 229 may couple to the antennas 235 and 236 in addition to, or instead of, coupling to the antennas 237 and 238. The short to medium range wireless communication circuitry 229 may include multiple receive chains and/or multiple transmit chains for receiving and/or transmitting multiple spatial streams, such as in a multiple-input multiple output (MIMO) configuration.

As shown, the SOC 200 may include processor(s) 202, which may execute program instructions for the wireless station 106 and display circuitry 204, which may perform graphics processing and provide display signals to the display 260. The processor(s) 202 may also be coupled to memory management unit (MMU) 240, which may be configured to receive addresses from the processor(s) 202 and translate those addresses to locations in memory (e.g., memory 206, read only memory (ROM) 250, NAND flash memory 210) and/or to other circuits or devices, such as the display circuitry 204, cellular communication circuitry 230, short range wireless communication circuitry 229, connector interface (I/F) 220, and/or display 260. The MMU 240 may be configured to perform memory protection and page table translation or set up. In some embodiments, the MMU 240 may be included as a portion of the processor(s) 202.

As described herein, the wireless station 106 may include hardware and software components for implementing the features described herein, e.g., the wireless station 106 may form at least part of a 3D display system such as systems 100A, 100B, 100C, and/or 100D as described herein. For example, the processor 202 of the wireless station 106 may be configured to implement part or all of the features described herein, e.g., by executing program instructions stored on a memory medium (e.g., a non-transitory computer-readable memory medium). Alternatively (or in addition), processor 202 may be configured as a programmable hardware element, such as an FPGA (Field Programmable Gate Array), or as an ASIC (Application Specific Integrated Circuit). Alternatively (or in addition) the processor 202 of the UE 106, in conjunction with one or more of the other components 200, 204, 206, 210, 212, 220, 230, 235, 240, 245, 250, 260 may be configured to implement part or all of the features described herein.

In addition, as described herein, processor 202 may include one or more processing elements. Thus, processor 202 may include one or more integrated circuits (ICs) that are configured to perform the functions of processor 202. In addition, each integrated circuit may include circuitry (e.g., first circuitry, second circuitry, etc.) configured to perform the functions of processor(s) 202.

FIGS. 3A and 3B illustrate examples of a user input device, according to some embodiments. As shown in FIG. 3A, a user input device 300 may be configured to perform various embodiments as described herein. User input device 300 may be similar to or the same as user input device 130 as described above in reference to FIGS. 1A, 1B, 1C, and 1D. Thus, user input device 300 may be used in conjunction with, or be included in, systems 100A, 100B, 100C and/or 100D. As described above, systems 100A, 100n, 100C, and/or 100D may have the capability to determine the six-axis position and orientation (e.g., pose) of user input device 300. Note that this includes the X, Y, Z location of a tip of user input device 300 and the a, J, y angular orientation of body 302 of user input device 300. However, it should be further noted that user input device 300 is exemplary, and that other user input devices, suitably configured, may be used as desired.

As shown, user input device 300 may include buttons 304, 306, and 312. In some instances, the buttons 304, 306, and/or 312 may be faux (or dummy) buttons. In other words, buttons 304, 306, and/or 312 may be non-functioning buttons, e.g., a system, such as systems 100A, 100B, 100C, and/or 100D described herein, may detect a user action of pressing a location of user input device 300 identified by the system as a button location. Hence, in some instances, buttons 304, 306, and/or 312 may be identifiable locations (e.g., via a visible marker, a raised area, and/or a dimpled or depressed area). In some instances, one of the buttons, such as button 306, may be “depressed” and “held down” to trigger the selection of an object within a 3D scene presented by any of systems 100A, 100B, 100C, and/or 100D. Additionally, system 100 may be configured to display a virtual “laser like” projection from a tip to the selected object. With the object selected, adjustment of the position and/or orientation of user input device 300 may change the position and/or orientation of the object. Thus, movements of the user input device 300 may result in corresponding translations and/or rotations of the object.

FIG. 3B illustrates an example simplified block diagram of a user input device 300. According to embodiments, user input device 300 may be an active stylus. As noted above, user input device 300 may be used in conjunction with the systems described above in reference to FIGS. 1A, 1B, 1C, and 1D. For example, user input device 300 may be configured as an input device to any of the described systems. In some embodiments, user input device 300 may be configured to communicate with a 3D system either wirelessly (e.g., via a local area network such as a Wi-Fi, Bluetooth, or Bluetooth low energy connection) or via a wired interface such as a universal serial bus (USB) interface, among other wired interfaces.

As shown, the user input device 300 may include a system on chip (SOC) 300, which may include portions for various purposes. The SOC 300 may be coupled to various other circuits of the user input device 300. For example, the user input device 300 may include various types of memory (e.g., including NAND flash 330), a connector interface (I/F) (or dock) 380 (e.g., for coupling to a computer system, dock, charging station, etc.), input(s) 370 (e.g., such as buttons 304, 306, and 312), and short to medium range wireless communication circuitry 329 (e.g., Bluetooth™ and WLAN circuitry). The short to medium range wireless communication circuitry 329 may also couple to one or more antennas, such as antennas 337 and 338 as shown. The short to medium range wireless communication circuitry 329 may include multiple receive chains and/or multiple transmit chains for receiving and/or transmitting multiple spatial streams, such as in a multiple-input multiple output (MIMO) configuration.

As shown, the SOC 300 may include processor(s) 322, which may execute program instructions for the user input device 300. The processor(s) 302 may also be coupled to memory management unit (MMU) 340, which may be configured to receive addresses from the processor(s) 322 and translate those addresses to locations in memory (e.g., memory 326, read only memory (ROM) 350, NAND flash memory 330) and/or to other circuits or devices, such as, short range wireless communication circuitry 329, connector interface (I/F) 380, input(s) 370, IMU(s) 312, and/or camera(s) 310. The MMU 340 may be configured to perform memory protection and page table translation or set up. In some embodiments, the MMU 340 may be included as a portion of the processor(s) 322.

As described herein, the user input device 300 may include hardware and software components for implementing the features described herein, e.g., the user input device 300 may form at least part of a 3D display system such as systems 100A, 100B, 100C, and/or 100D described herein. For example, the processor 322 of the user input device 300 may be configured to implement part or all of the features described herein, e.g., by executing program instructions stored on a memory medium (e.g., a non-transitory computer-readable memory medium). Alternatively (or in addition), processor 322 may be configured as a programmable hardware element, such as an FPGA (Field Programmable Gate Array), or as an ASIC (Application Specific Integrated Circuit). Alternatively (or in addition) the processor 322 of the user input device 300, in conjunction with one or more of the other components 320, 340, 350, 326, 330, 312, 310, 329, 337, 338, 370, and/or 380 may be configured to implement part or all of the features described herein.

In addition, as described herein, processor 322 may include one or more processing elements. Thus, processor 322 may include one or more integrated circuits (ICs) that are configured to perform the functions of processor 322. In addition, each integrated circuit may include circuitry (e.g., first circuitry, second circuitry, etc.) configured to perform the functions of processor(s) 322.

In some instances, user input device 300 may (optionally) include one or more cameras, such as camera 310 with corresponding lens 314. The one or more cameras 310 may be wide-angle video cameras, at least in some instances. In some instances, the one or more cameras may be monochromatic and/or color cameras. As shown, a first camera of the one or more cameras 310 may be located at the tip of the user input device 300. Thus, the first camera may capture images (e.g., video and or a sequence of images) in a direction that the stylus is pointing, e.g., such as at a display screen of systems 100A, 100B, 100C, and/or 100D. In some instances, a wide-angle camera may be used in an effort to capture at least three corners of the display screen, thereby aiding in orienting (e.g., in 3D space) the user input device 300 relative to the display. In other words, the first camera may aid in determining a pose of the user input device 300. In some instances, the lens 314 may be a prism or other optic that may allow two simultaneous views from the first camera. For example, the view from the first camera may be split between a first view directed in the direction of the tip of the user input device 300 and a second view directed down from the direction of the tip of the user input device. In this manner, the first camera may have a first view corresponding to a view of a display and a second view corresponding to a view of a keyboard.

In some instances, the user input device 300 may (optionally) include a second camera 310 (e.g., a second camera of the one or more cameras). The second camera may be oriented in a down-ward facing direction, e.g., to capture images (e.g., sequences of images and/or video) of a keyboard of systems 100A, 100B, 100C, and/or 100D. Such a scheme may allow for tracking of the user input device 300 when the first camera is not directed towards the display.

In some instances, the user input device 300 may include one or more inertial measurement units (IMUs), such as IMU 312. Each IMU may include a gyroscope, a compass, and/or an accelerometer. Each IMU may provide information associated with motion of the user input device 300 in 3D space and may aid in determination of changes in position and/or orientation of the user input device 300.

As noted above, the user input device 300 may include one or more processors 322. The one or more processors 322 may be in communication with the one or more cameras and the one or more IMUs. The one or more processors 322 may be configured to determine a position and/or orientation (e.g., pose) of the user input device 300 in 3D space, e.g., relative to a display and/or relative to a 3D display system. For example, the user input device 300 may determine its pose in 3D space and transmit the pose (e.g., continuously and/or in real-time) to a 3D display system via a wired or unwired (e.g., via Bluetooth, Wi-Fi, and/or an other wireless communication standard) connection. Thus, the user input device 300 may further include a communication interface, e.g., such as a wireless interface comprising at least one radio (e.g., Bluetooth/WLAN Radio 329) and one or more antennas (e.g., antennas 337 and/or 338).

In some instances, the one or more processors 322 may be configured to capture images. e.g., digital photographs and/or videos, via the one or more cameras 310. These images could be sent to a display for viewing and/or to a printer. In addition, the one or more processors may be configured to operate as a document scanner, a 3D scanner for virtual 3D re-construction of real-world objects, a barcode scanner, a quick response (QR) code scanner, a digital (or virtual) writing tool, a digital (or virtual) painting tool, and so forth.

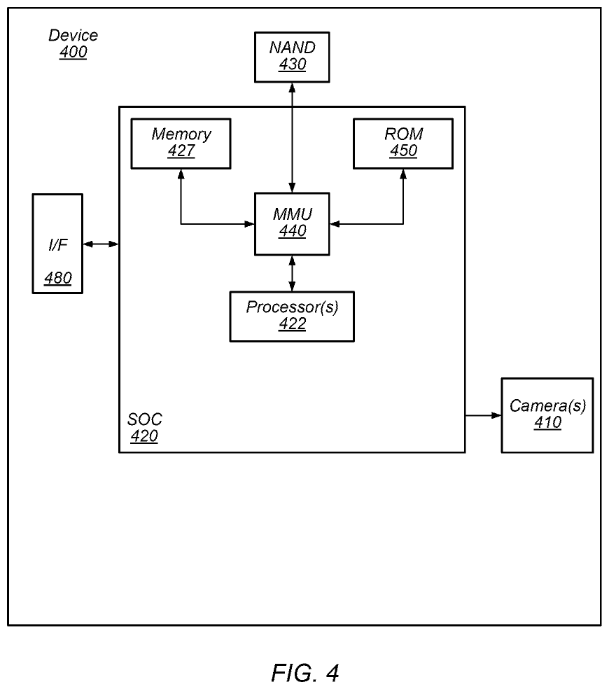

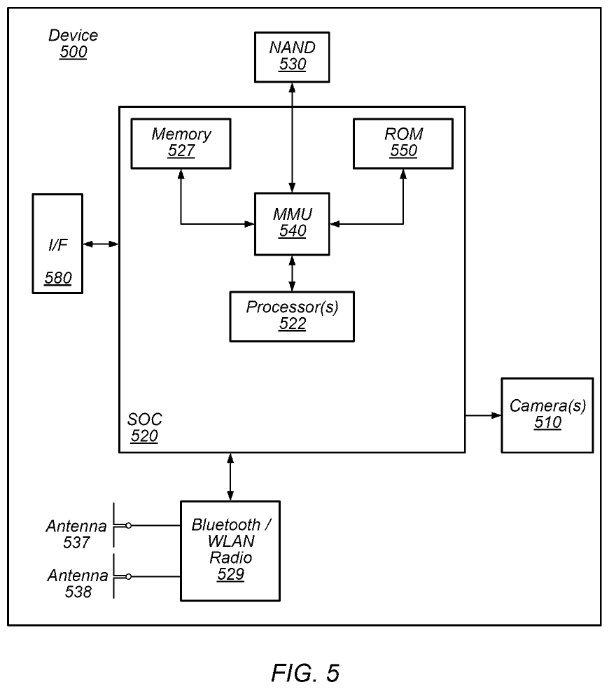

FIGS. 4 and 5 illustrate example simplified block diagrams of a device configured to determine an angle of a first surface relative to a mounting surface. Turning to FIG. 4, a device 400 may be used in conjunction with the systems described herein, such as system 100B as described herein.

As shown, the device 400 may include a system on chip (SOC) 420, which may include portions for various purposes. The SOC 420 may be coupled to various other circuits of the device 400. For example, the device 400 may include various types of memory (e.g., including NAND flash 430), and/or a connector interface (I/F) (or dock) 480 (e.g., for coupling to a computer system, dock, charging station, etc.), The I/F 480 may be configured to operate a universal serial bus (USB) port and/or interface, at least in some instances. In other instances, the I/F 480 may be configured to operate based on other communication and/or interface types. In some instances, the I/F 480 may be further configured to couple to a user input device, such user input device 300, e.g., to “dock” the user input device to system 100B and/or to allow charging of user input device 300 by system 100B.

As shown, the SOC 420 may include processor(s) 422, which may execute program instructions for the device 400. The processor(s) 422 may also be coupled to memory management unit (MMU) 440, which may be configured to receive addresses from the processor(s) 422 and translate those addresses to locations in memory (e.g., memory 427, read only memory (ROM) 450, NAND flash memory 430) and/or to other circuits or devices, such as the connector interface (I/F) 480 and/or camera(s) 410. The MMU 440 may be configured to perform memory protection and page table translation or set up. In some instances, the MMU 440 may be included as a portion of the processor(s) 422.

As described herein, the device 400 may include hardware and software components for implementing the features described herein, e.g., the device 400 may form at least part of a 3D display system such as system 100B described herein. For example, the processor 422 of the device 400 may be configured to implement part or all of the features described herein, e.g., by executing program instructions stored on a memory medium (e.g., a non-transitory computer-readable memory medium). Alternatively (or in addition), processor 422 may be configured as a programmable hardware element, such as an FPGA (Field Programmable Gate Array), or as an ASIC (Application Specific Integrated Circuit). Alternatively (or in addition) the processor 422 of the device 400, in conjunction with one or more of the other components 410, 420, 427, 430, 440, 450, and/or 480 may be configured to implement part or all of the features described herein.

In addition, as described herein, processor 422 may include one or more processing elements. Thus, processor 422 may include one or more integrated circuits (ICs) that are configured to perform the functions of processor 422. In addition, each integrated circuit may include circuitry (e.g., first circuitry, second circuitry, etc.) configured to perform the functions of processor(s) 422.

Further, as described herein, camera(s) 410 may be arranged on device 400 such that camera(s) 410 include at least a portion of a display of a system, such as display 150 of system 100B, within its field of view, e.g., when the device 400 is attached (e.g., via an interface/dock such as Dock I/F 220) to system 100B. In some instances, the field of view may be an oblique field of view. In some instances, using images captured from camera(s) 410, the device 400 (e.g., processor 422 of device 400) may be configured to track, determine, and/or estimate a position (e.g., angle of orientation) of the display 150 of system 100B. Further, the device 400 may be configured to provide (e.g., via an interface with system 100B supported at least by I/F 480 and/or Dock I/F 220) the position of the display 150 to system 100B. In some instances, the device 400 may be (alternatively and/or additionally) configured to provide (e.g., via an interface with system 100B supported at least by I/F 480 and/or Dock I/F 220) the images to associated and/or corresponding software executing on system 100B. For example, to aid in determination of an angle between the display 150 of system 100B and the chassis 110B and/or keyboard 120 of the system 100B, the angle between the display and the chassis/keyboard may be determined (e.g., by the device 400 and/or by the associated and/or corresponding software executing on system 100B) based, at least in part, on an oblique view of at least a portion of the display 150. The angle between the display and the chassis/keyboard may be determined, e.g., in real-time, based on a pre-determined reference between a point of view of the camera(s) 410 and the display 150. The view of the portion of the display 150 may be considered an area-of-interest (AoI), at least in some instances. The pre-determined reference may be considered a calibration, at least in some instances. Thus, in some instances, the device 400 may be moveable between systems with calibration, e.g., the device 400 may include a calibration mechanism to allow the device 400 to be used across varying computer systems 100B.

Turning to FIG. 5, a device 500 may be used in conjunction with the systems described herein, such as system 100B as described herein.

As shown, the device 500 may include a system on chip (SOC) 520, which may include portions for various purposes. The SOC 520 may be coupled to various other circuits of the device 500. For example, the device 500 may include various types of memory (e.g., including NAND flash 530), and/or a connector interface (I/F) (or dock) 580 (e.g., for coupling to a computer system, dock, charging station, etc.). The I/F 580 may be configured to operate a universal serial bus (USB) port and/or interface, at least in some instances. In other instances, the I/F 580 may be configured to operate based on other communication and/or interface types. In some instances, the I/F 580 may be further configured to couple to a user input device, such user input device 300, e.g., to “dock” the user input device to system 100B and/or to allow charging of user input device 300 by system 100B.

As shown, the SOC 520 may include processor(s) 522, which may execute program instructions for the device 500. The processor(s) 522 may also be coupled to memory management unit (MMU) 540, which may be configured to receive addresses from the processor(s) 522 and translate those addresses to locations in memory (e.g., memory 527, read only memory (ROM) 550, NAND flash memory 530) and/or to other circuits or devices, such as the connector interface (I/F) 580, camera(s) 510, and/or and short to medium range wireless communication circuitry 529 (e.g., Bluetooth™ and WLAN circuitry). The MMU 540 may be configured to perform memory protection and page table translation or set up. In some instances, the MMU 540 may be included as a portion of the processor(s) 522. The short to medium range wireless communication circuitry 529 may also couple to one or more antennas, such as antennas 537 and 538 as shown. The short to medium range wireless communication circuitry 529 may include multiple receive chains and/or multiple transmit chains for receiving and/or transmitting multiple spatial streams, such as in a multiple-input multiple output (MIMO) configuration.

As described herein, the device 500 may include hardware and software components for implementing the features described herein, e.g., the device 500 may form at least part of a 3D display system such as system 100B described herein. For example, the processor 522 of the device 500 may be configured to implement part or all of the features described herein, e.g., by executing program instructions stored on a memory medium (e.g., a non-transitory computer-readable memory medium). Alternatively (or in addition), processor 522 may be configured as a programmable hardware element, such as an FPGA (Field Programmable Gate Array), or as an ASIC (Application Specific Integrated Circuit). Alternatively (or in addition) the processor 522 of the device 500, in conjunction with one or more of the other components 510, 520, 527, 530, 540, 550, and/or 580 may be configured to implement part or all of the features described herein.

In addition, as described herein, processor 522 may include one or more processing elements. Thus, processor 522 may include one or more integrated circuits (ICs) that are configured to perform the functions of processor 522. In addition, each integrated circuit may include circuitry (e.g., first circuitry, second circuitry, etc.) configured to perform the functions of processor(s) 522.

Further, as described herein, camera(s) 510 may be arranged on device 500 such that camera(s) 510 include at least a portion of a chassis of a system, such as system 100n, within its field of view, e.g., when the device 500 is attached (e.g., via a mechanical and/or magnetic attachment point) to system 100B. In some instances, the field of view may be an oblique field of view. In some instances, using images captured from camera(s) 510, the device 500 (e.g., processor 522 of device 500) may be configured to track, determine, and/or estimate a position (e.g., angle of orientation) of the display 150 of system 100B. Further, the device 500 may be configured to provide (e.g., via an interface with system 100B supported at least by I/F 580 and/or Dock I/F 220 and/or wirelessly via short range communication circuitry 529) the position of the display 150 to system 100B. In some instances, the device 500 may be (alternatively and/or additionally) configured to provide (e.g., via an interface with system 100B supported at least by I/F 580 and/or Dock I/F 220 and/or wirelessly via short range communication circuitry 529) the images to associated and/or corresponding software executing on system 100B. For example, to aid in determination of an angle between the display 150 of system 100B and the chassis 110B and/or keyboard 120 of the system 100B, the angle between the display and the chassis/keyboard may be determined (e.g., by the device 500 and/or by the associated and/or corresponding software executing on system 100B) based, at least in part, on an oblique view of at least a portion of the system 100B. The angle between the display and the chassis/keyboard may be determined, e.g., in real-time, based on a pre-determined reference between a point of view of the camera(s) 510 and the system 100B. The view of the portion of the system 100B may be considered an area-of-interest (AoI), at least in some instances. The pre-determined reference may be considered a calibration, at least in some instances. Thus, in some instances, the device 500 may be moveable between systems with calibration, e.g., the device 500 may include a calibration mechanism to allow the device 500 to be used across varying computer systems 100B.

### Display Position Determination

In the current art of three-dimensional (3D) augmented or virtual reality (AR/VR) interactive scenes, one key aspect of presenting 3D AR/VR interactive scenes is determination of a point of view of a user relative to a display of a computer system. As prior art systems have evolved from static desktop systems in which the display was fixed in relation to a user to portable systems (e.g., such as laptops with clamshell chassis) in which the display is no longer fixed in relation to a user, the determination of the point of view of the user relative to the display has become more complex. For example, as an angle of a portable display system changes relative to a base of the system, an orientation of the user relative to the display may change independent of motion of the user. Thus, user tracking, e.g., via tracking systems integrated into the portable system, has become more complex, both in terms of tracking hardware and tracking algorithms.

Therefore, improvements in display position are desired.

Embodiments described herein provide systems, methods, and mechanisms for display position estimation and/or determination, including methods performed by a portable device, e.g., a universal serial bus (USB) device comprising at least one camera, a wireless portable device comprising at least one camera that may be mountable (e.g., mechanically and/or magnetically) to a display and/or chassis of a computer system (and may include at least one radio configured to communicate with a computer system), and/or a user equipment device (UE), such as a laptop computer, comprising at least one camera arranged to include at least a portion of a display of the laptop within a field of view of the at least one camera and/or a laptop computer comprising at least one camera arranged to include at least a portion of a chassis/keyboard within a field of view of the at least one camera, to track, determine, and/or estimate a position (e.g., angle of orientation) of a display of the laptop computer. For example, to aid in determination of an angle between a display of a laptop and a chassis and/or keyboard of the laptop, the angle between the display and the chassis/keyboard may be determined based, at least in part, on an oblique view of at least a portion of the display. The angle between the display and the chassis/keyboard may be determined, e.g., in real-time, based on a pre-determined reference between a point of view of a camera positioned to view at least a portion of the display and the display. The view of the portion of the display may be considered an area-of-interest (AoI), at least in some instances. The pre-determined reference may be considered a calibration, at least in some instances. Thus, in some instances, the portable device may be moveable between systems with calibration, e.g., the portable device may include a calibration mechanism to allow the portable device to be used across varying computer systems. For example, there may be multiple approaches to calibration. In some instances, an external device incorporating an IMU (Inertial Measurement Unit) attached to a screen of a target computer system may be used to establish ground truth readings for screen angle. Those ground truth readings may then become a pre-determined calibrated reference. In some instances, the device may be a purpose-built calibrator. In other instances, the device may be a user equipment device (UE) (e.g., a smart phone) that may be attached to the screen of the target computer.

For example, in some instances, an image may be captured by the at least one camera and compared, e.g., in real-real time, to a cached set of previously captured screen position images (e.g., calibration images). Further, in some instances, the cached set of previously captured screen position images may include metadata associated with and/or regarding a value of a screen angle. Thus, when a resulting match is found from the image comparison, the screen angle may be determined, calculated, and/or derived based on the metadata associated with a matched image from the set of images. In some instances, when an exact match between a captured image and a cached image from the set of images is not found and/or determined, the screen angle may be determined, calculated, and/or derived via interpolation based on metadata associated with two or more nearest matched images. In other words, since the cached set of previously captured screen position images is finite, interpolation may be introduced to determine, calculate, and/or derive the screen angle based on available metadata. In some instances, the comparison may be performed using a fuzzy image matching algorithm. For example, Fuzzy image-matching algorithms may be considered as a class of algorithms operating on digitized images and calculating a numeric value reflecting the similarity between two given input images. One common approach is building so-called feature vectors for each given image and then performing KNN (K-Nearest-Neighbor) searches over pre-calculated feature vectors.

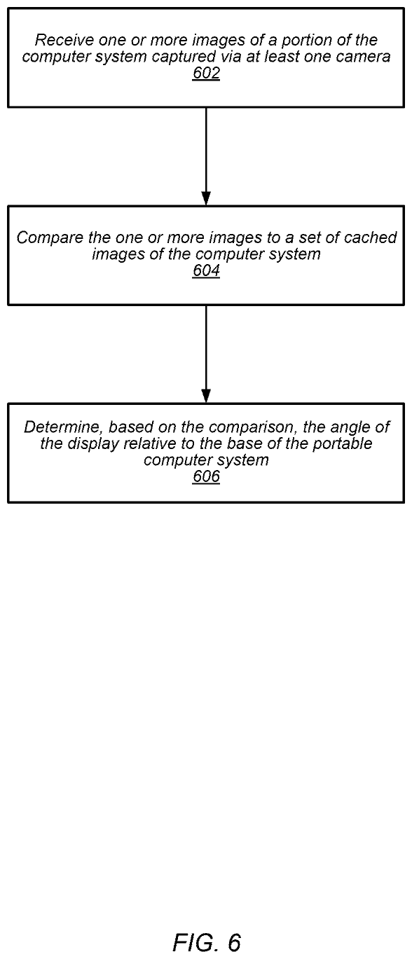

FIG. 6 illustrates a block diagram of an example of a method for determining an angle of a display relative to a base of a portable computer system, according to some embodiments. The method shown in FIG. 6 may be used in conjunction with any of the systems, methods, or devices shown in the Figures, among other devices. In various embodiments, some of the method elements shown may be performed concurrently, in a different order than shown, or may be omitted. Additional method elements may also be performed as desired. As shown, this method may operate as follows.

At 602, a portable computer system, such as system 100B, may receive one or more images of a portion of the portable computer system captured via at least one camera, e.g., via at least one camera of a portable device, such as devices 400 and/or 500. In some instances, to receive the one or more images of the portion of the portable computer system captured via the at least one camera, the portable computer system may receive the one or more images via communications with a portable device, such as device 400 and/or device 500, that includes the at least one camera. In some instances, the communications may be wireless communications, e.g., such as wireless communications are according to at least one of (and/or one or more of) a Wi-Fi based communications protocol and/or a Bluetooth based communications protocol. In some instances, the communications may be supported by an input/output bus and/or peripheral bus between the portable device and the portable computer system, e.g., such as a universal serial bus.

In some instances, the one or more images may include an oblique view of at least a portion of the portable computer system, an oblique view of at least a portion of the display, and/or an oblique view of at least a portion of the base. In some instances, the one or more images may include one or more area of interests (AoIs). The one or more AoIs may include distinctive markings or patterns.

In some instances, the at least one camera may be a wide-angle camera. In some instances, the at least one camera may be a monochromatic camera and/or a color camera.

At 604, the portable computer system may compare the one or more images to a set of cached images of the portable computer system. In some instances, the one or more images may include and/or be one or more fuzzy images. In such instances, to compare, the one or more images to the set of cached images of the portable computer system comprises comparing the one or more images to a set of cached images of the portable computer system via a fuzzy image matching algorithm.

In some instances, the portable computer device may compile the set of cached images via a calibration algorithm. The calibration algorithm may include the portable device receive images via the at least one camera at a fixed angular interval, e.g., as measured by a user equipment device (UE) attached to the display and/or as measured by a calibration device attached to the display. In some instances, the fixed angular interval may be one degree or less, five degrees or less, and/or ten degrees or less. In some instances, each cached image of the set of cached images may include metadata associated with a value of an angle between the display and the base of the portable computer system.

At 606, the portable computer system may determine, e.g., based on the comparison, the angle of the display relative to the base of the portable computer system. In some instances, to determine, based on the comparison, the angle of the display relative to the base of the portable computer system, the portable computer system may determine that none of the set of cached images are an exact match to the one or more images, select two or more nearest matched images of the set of cached images, and determine the angle of the display relative to the base via an interpolation using the two or more nearest matched images.

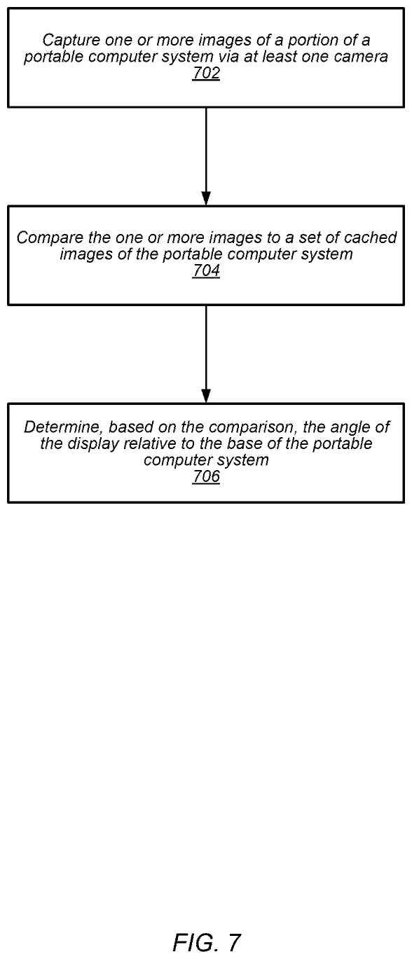

FIG. 7 illustrates a block diagram of another example of a method for determining an angle of a display relative to a base of a portable computer system, according to some embodiments. The method shown in FIG. 7 may be used in conjunction with any of the systems, methods, or devices shown in the Figures, among other devices. In various embodiments, some of the method elements shown may be performed concurrently, in a different order than shown, or may be omitted. Additional method elements may also be performed as desired. As shown, this method may operate as follows.

At 702, a device, such as device 400 and/or device 500, may capture one or more images of a portion of a portable computer system, such as system 100B, via at least one camera. In some instances, the one or more images may include an oblique view of at least a portion of the portable computer system. In some instances, the one or more images may include an oblique view of at least a portion of the display. In some instances, the one or more images may include an oblique view of at least a portion of the base of the portable computer system. In some instances, the one or more images include one or more area of interests (AoIs). The one or more AoIs may include distinctive markings or patterns. In some instances, the at least one camera may be a wide-angle camera. In some instances, the at least one camera may be a monochromatic camera and/or a color camera.

At 704, the device may compare the one or more images to a set of cached images of the portable computer system. In some instances, the one or more images may include one or more fuzzy images. In such instances, to compare one or more images to a set of cached images of the portable computer system, the device may compare the one or more images to a set of cached images of the portable computer system via a fuzzy image matching algorithm.

In some instances, the device may compile the set of cached images via a calibration algorithm. The calibration algorithm may include the device capturing images via the at least one camera at a fixed angular interval, e.g., as measured by a user equipment device (UE) attached to the display and/or as measured by a calibration device attached to the display. The fixed angular interval may one degree or less, five degrees or less, and/or ten degrees or less. In some instances, each cached image of the set of cached images may include metadata associated with a value of an angle between the display and the base of the portable computer system.

At 706, the device may determine, e.g., based on the comparison, an angle of a display of the portable computer system relative to the base of the portable computer system. In some instances, to determine, based on the comparison, the angle of the display relative to the base of the portable computer system, the device may determine that none of the set of cached images are an exact match to the one or more images, select two or more nearest matched images of the set of cached images, and determine the angle of the display relative to the base via an interpolation using the two or more nearest matched images.

In some instances, the device may provide the angle of the display to the computer system. In some instances, to provide the angle of the display to the portable computer system, the device may transmit the one or more images via communications with the computer system. In some instances, each of the one or more images may include metadata indicating an angle of the display of the portable computer system relative to the base of the portable computer system. In some instances, the communications may be and/or include wireless communications, e.g., such as wireless communications according to at least one of (and/or one or more of) a Wi-Fi based communications protocol or a Bluetooth based communications protocol. In some instances, the communications may be supported by an input/output bus and/or peripheral bus of the portable computer system, e.g., such as a universal serial bus.

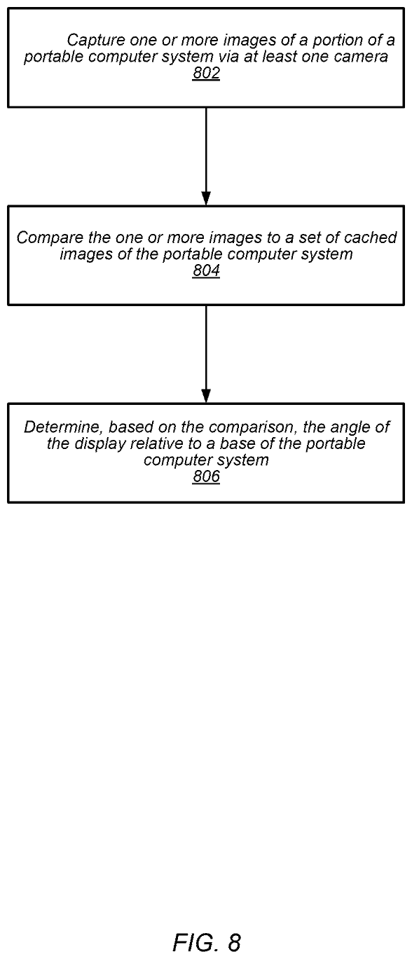

FIG. 8 illustrates a block diagram of a further example of a method for determining an angle of a display relative to a base of a portable computer system, according to some embodiments. The method shown in FIG. 8 may be used in conjunction with any of the systems, methods, or devices shown in the Figures, among other devices. In various embodiments, some of the method elements shown may be performed concurrently, in a different order than shown, or may be omitted. Additional method elements may also be performed as desired. As shown, this method may operate as follows.

At 802, a portable computer system, such as system 100C and/or 100D, may capture one or more images of a portion of the portable computer system via at least one camera. In some instances, the one or more images may include an oblique view of at least a portion of the portable computer system, an oblique view of at least a portion of the display, and/or an oblique view of at least a portion of the base. In some instances, the one or more images may include one or more area of interests (AoIs). The one or more AoIs may include distinctive markings or patterns. In some instances, the at least one camera may be a wide-angle camera. In some instances, the at least one camera may be a monochromatic camera and/or a color camera.

At 804, the portable computer system may compare the one or more images to a set of cached images of the portable computer system. In some instances, the one or more images may include and/or be one or more fuzzy images. In such instances, to compare, the one or more images to the set of cached images of the portable computer system comprises comparing the one or more images to a set of cached images of the portable computer system via a fuzzy image matching algorithm.

In some instances, the portable computer device may compile the set of cached images via a calibration algorithm. The calibration algorithm may include the portable device capturing images via the at least one camera at a fixed angular interval, e.g., as measured by a user equipment device (UE) attached to the display and/or as measured by a calibration device attached to the display. In some instances, the fixed angular interval may be one degree or less, five degrees or less, and/or ten degrees or less. In some instances, each cached image of the set of cached images may include metadata associated with a value of an angle between the display and the base of the portable computer system.

At 806, the portable computer system may determine, e.g., based on the comparison, the angle of the display relative to the base of the portable computer system. In some instances, to determine, based on the comparison, the angle of the display relative to the base of the portable computer system, the portable computer system may determine that none of the set of cached images are an exact match to the one or more images, select two or more nearest matched images of the set of cached images, and determine the angle of the display relative to the base via an interpolation using the two or more nearest matched images.

Although the embodiments above have been described in considerable detail, numerous variations and modifications will become apparent to those skilled in the art once the above disclosure is fully appreciated. It is intended that the following claims be interpreted to embrace all such variations and modifications.

We claim:

1. A method for determining an angle of a display relative to a base of a portable computer system, comprising:
receiving one or more images of a portion of the portable computer system captured via at least one camera;
comparing the one or more images to a set of cached images of the computer system; and
determining, based on the comparison, the angle of the display relative to the base of the portable computer system.

2. The method of claim 1,
wherein receiving the one or more images of the portion of the portable computer system captured via the at least one camera comprises, receiving the one or more images via communications with a portable device comprising the at least one camera.

3. The method of claim 2,
wherein the communications comprise wireless communications.

4. The method of claim 3,
wherein the wireless communications are according to at least one of a Wi-Fi based communications protocol or a Bluetooth based communications protocol.

5. The method of claim 2,
wherein the communications are supported by an input/output bus and/or peripheral bus between the portable device and the portable computer system.

6. The method of claim 5,
wherein the input/output bus and/or peripheral bus comprises a universal serial bus.

7. The method of claim 1,
wherein the one or more images comprise one or more fuzzy images.

8. The method of claim 7,
wherein comparing the one or more images to a set of cached images of the portable computer system comprises comparing the one or more images to a set of cached images of the portable computer system via a fuzzy image matching algorithm.

9. A non-transitory computer readable memory medium storing program instructions executable by at least one processor of a portable computer system to cause the portable computer system to:
receive one or more images of a portion of the portable computer system captured via at least one camera;
compare the one or more images to a set of cached images of the computer system; and
determine, based on the comparison, an angle of a display of the portable computer system relative to a base of the portable computer system.

10. The non-transitory memory medium of claim 9,
wherein the program instructions are further executable by the at least one processor of the portable computer system to cause the portable computer system to compile the set of cached images via a calibration algorithm.

11. The non-transitory memory medium of claim 10,
wherein, to perform the calibration algorithm, the program instructions are further executable by the at least one processor of the portable computer system to cause the portable computer system to receive images via the at least one camera at a fixed angular interval.

12. The non-transitory memory medium of claim 11,
wherein the fixed angular interval is one degree or less, five degrees or less, or ten degrees or less.

13. The non-transitory memory medium of claim 9,
wherein each cached image of the set of cached images includes metadata associated with a value of an angle between the display and the base of the portable computer system.

14. The non-transitory memory medium of claim 9,
wherein the one or more images include an oblique view of at least a portion of the portable computer system.

15. The non-transitory memory medium of claim 9,
wherein the one or more images include an oblique view of at least a portion of the display.

16. A portable computer system, comprising:
at least one display;
a memory; and
at least one processor in communication with the memory and configured to cause the portable computer system to:
receive one or more images of a portion of the portable computer system captured via at least one camera;
compare the one or more images to a set of cached images of the computer system; and
determine, based on the comparison, an angle of the at least one display relative to a base of the portable computer system.

17. The portable computer system of claim 16,
wherein the one or more images include an oblique view of at least a portion of the base.

18. The portable computer system of claim 16,
wherein the one or more images include one or more area of interests (AoIs).

19. The portable computer system of claim 18,
wherein the one or more AoIs include distinctive markings or patterns.

20. The portable computer system of claim 16,
wherein, to determine, based on the comparison, the angle of the display relative to the base of the portable computer system, the at least one processor is further configured to cause the portable computer system to:
determine that none of the set of cached images are an exact match to the one or more images;
select two or more nearest matched images of the set of cached images; and
determine the angle of the display relative to the base via an interpolation using the two or more nearest matched images.
